(19) United States
(12) Patent Application Publication
(10) Pub. No.: US 2024/0092119 A1
(43) Pub. Date: Mar. 21, 2024

(54) TWO-DIMENSIONAL MATERIAL PRINTER AND TRANSFER SYSTEM

(71) Applicant: The George Washington University, Washington, DC (US)

(72) Inventor: Volker J. SORGER, Alexandria, VA (US)

(21) Appl. No.: 18/140,454

(22) Filed: Apr. 27, 2023

Related U.S. Application Data
(60) Provisional application No. 63/335,495, filed on Apr. 27, 2022.

(51) Int. Cl. B44C 1/17

(52) U.S. Cl. CPC B44C 1/1733

(57) ABSTRACT

A material transfer system transfers 2-dimensional (2D) material to or from a substrate. The system comprises a transfer apparatus having a transfer material holder for retaining a transfer material, and a stamping apparatus having an intermediate portion with a longitudinal axis and a distal end portion. The distal end portion has a proximal section, middle section and distal section forming a distal end face. The middle section is curved with respect to the longitudinal axis to form a stamper contact surface at the middle section. The stamper contact is surface configured to contact the transfer material.

### RELATED APPLICATION

This application claims the benefit of priority of U.S. Provisional Application No. 63/335,495, filed on Apr. 27, 2022, the entire content of which is relied upon and incorporated herein by reference in its entirety.

### Related Publications

This application is related to U.S. Patent Publ. No. 2021/0178738 and U.S. Pat. No. 10,919,280 and C. Patil, Highly Accurate, Reliable, and Non-Contaminating Two-Dimensional Material Transfer System, Appl. Phys. Ref 9, 011419, Feb. 24, 2022, the entire contents of which are incorporated herein by reference.

### GOVERNMENT LICENSE RIGHTS

This invention was made with Government support under Contract No. 1436330 awarded by NSF. The U.S. Government has certain rights in this invention.

### BACKGROUND OF THE INVENTION

### Field of the Invention

The present invention relates to a two-dimensional material printer. More particularly, the present invention relates to a system and method for transfer of atomically layered materials.

### BACKGROUND OF THE RELATED ART

Two-dimensional (2D) materials hold promise for atomic-scale and highly-functional electronic and photonic devices by taking advantage of their rich physical properties which are fundamentally different from their bulk counterparts. [1]-[7] The diverse bandgap range of atomically-layered materials include insulators hexagonal Boron Nitride (hBN), semiconductors (MoS₂, MoSe₂, WS₂ etc.), and semimetals (graphene) providing the opportunity to realize heterostructures without the conventional lattice mismatch known from, for instance, integrating III-V materials with group IV substrates. [8]-[17]

Graphene, the first member of the 2D family, shows semi metallic electronic properties and has proven to be a key active material for a wide range of applications including in the optoelectronic industry. [2], [3] On the other hand, semiconductor transition metal dichalcogenides (TMDCs) and black phosphorus demonstrate thickness dependent bandgap tunability covering the visible and near infrared spectrum and direct bandgap with high emission yields. [18]-[21] Additionally, hBN is an ideal insulator for 2D material heterostructure platform given its bandgap of ˜5.9 eV. [11]-[13] Strong in-plane covalent bonds provide stability of 2D crystals, whereas the vertical layers of 2D material are held together by weak Van der Waals forces and can be easily separated through the mechanical exfoliation method. [21]

In contrast, chemical vapor deposition (CVD) offers chip-scale 2D material growth relevant for industry. [22] However, in addition to quality imperfections, both the thermal budget and substrate incompatibility currently limit CVD growth methods, despite significant progress having been made. [23]

Hence, the scalability of obtaining these 2D materials and the ability to reliably transfer a 2D material flake onto an arbitrary substrate with minimum cross-contamination remains challenging unless it is a single transfer from a clean source of 2D material flakes. The capability to transfer, for instance, a single flake to a target area from a relatively dense source is important because neighboring features such as other devices, circuits, or photonics waveguide structures, could be harmed if the 2D material flake areas are randomly introduced onto the target substrate. On the other hand, it will enable to transfer multiple times from a given source.

Previous transfer approaches, such as the wedging method, use wet chemistry to transfer 2D materials. [24] Whereas, the polymer (evalcite) transfer method involves the substrate heating and wet chemistry to obtain a successful transfer. [25] As described, current transfer methods do not encompass the precautions to protect neighboring devices; this could become critical for heterogeneous integration such as carried out in Silicon photonics. [26], [27] With each method, there is a drawback that could harm a specific electronic or photonic device, whether it be chemicals, heating, excess residue, etc.

Precision and chip contamination-free placement of two-dimensional (2D) materials is expected to accelerate both the study of fundamental properties and novel device functionality. But current deterministic transfer methods of 2D materials onto an arbitrary substrate deploy viscoelastic stamping. However, these methods produce a) significant cross-contamination of the substrate inherent from typical dense sources of 2D material flakes and b) are challenged with respect to spatial alignment, and c) multi-transfer at a single step.

Referring to FIG. 1, several techniques of dry transfer of 2D materials are illustrated: Direct or Scotch tape exfoliation technique (FIG. 1(a)), Dry (FIG. 1(b)), and Lithography (also referred to here as Litho Assisted) (FIG. 1(c)). FIG. 1(a) is a direct transfer technique. See K. S. Novoselov et al, Electric Field Effect in Atomically Thin Carbon Films, Science 22 Oct. 2004: Vol. 306, Issue 5696, pp. 666-669 DOI: 10.1126/science.1102896. Here, a piece of scotch tape with exfoliated flakes on it is directly placed onto the substrate. The mechanical exfoliation involves placing a bulk crystal or substrate between two pieces of adhesive tape (Scotch or Nitto tape) and then peeling one tape off the other. [28] This action breaks weak Van der Waals interactions keeping the layers of crystal together and essentially thins it down. This procedure is repeated numerous times until ideally a flake with desired thickness is obtained. This simple and quick approach always offers optimal quality layered materials. However, one major limitation is to control the thickness and lateral dimensions of the flakes. The obtained flakes differ considerably in size and thickness, where the sizes range from nanometers to several tens of micrometers for single to few layers 2D materials.

Turning to FIG. 1(b), a schematic is shown of the deterministic dry transfer method. See Andres Castellanos-Gomez et al., Deterministic transfer of two-dimensional materials by all-dry viscoelastic stamping, Published 4 Apr. 2014 IOP Publishing Ltd, 2D Materials, Volume 1, Number 1. The exfoliated flakes are transferred to a Polydimethylsiloxane (PDMS) gel from the scotch tape and the gel is then aligned with the substrate. Since the PDMS is transparent, it is possible to see both the flake on the gel and the target area on the substrate simultaneously. Both the gel and the substrate are on micromanipulator stages, once the flake is aligned with the target area, we lower the gel to the substrate. We then lift off the gel slowly, leaving the flakes on the substrate.

Turning to FIG. 1(c), a schematic is shown of the lithography-assisted deterministic dry transfer method (Litho-Assisted). The same steps of the Dry transfer method are followed. However, the substrate is coated in PMMA and an opening created by using Electron Beam Lithography (EBL). When the PDMS gel is push down on the PMMA coated substrate, all the flakes in contact with the PMMA/substrate will transfer but only the flakes that are within the EBL opening will stay. The rest will get washed off with acetone along with the PMMA similar to the conventional lift-off process.

To quantify the amount of cross-contamination for the transfer techniques for Direct (FIG. 1(a)), Dry (FIG. 1(b)), and Litho-assisted (FIG. 1(c)) (as well as for the present invention), we optically measure the sum of all undesired transferred flakes (A_{access}) in a certain predefined chip area (A_{box}). Here, A_{box} is a multiple (f=100×, 400×, and 900×) of the flake area (A_{flake}) in order to account for varying flake sizes (i.e. A_{box}=f×A_{flake}). Then the cross-contamination is obtained via

$$C C = {( \frac{\sum {A}_{access}}{{A}_{box}} )}_{f} \qquad ( 1 )$$

Repeating the transfer experiment for each method 10 times, we can fit the resulting distributions with a Gaussian function, since each experiment is an independent sample. The resulting mean values (μ̅) and standard deviations (σ) from the fitting show that the spatial cross-contamination spread is most significant when considering small areas around the target transferred flake (i.e. A_{box}=100×) (FIG. 3(d)). This can be understood by the spatial distribution of the 2D source use for the transfer method; the repeated mechanical stamping (often manual pressing) on a similar location using scotch-tape during exfoliation leads to clustering of 2D materials. Thus, both the Direct and the Dry transfer methods (FIGS. 1(a), (b)) show an anticipated CC improvement with larger A_{box}, highlighting the ‘edge’ of the cluster area.

We briefly summarize the conceptual methodology of the Direct, and Dry transfer methods to provide a holistic picture of the steps involved in each. The Direct transfer approach (FIG. 1(a)) involves using mechanical exfoliation techniques using adhesive tape (Scotch or Nitto) and then, we bring scotch tape with the exfoliated flakes in direct contact with the substrate FIG. 1(a). [28] This approach is quick; however, there is no alignment to place a flake on a target area to the substrate.

In the Dry Transfer approach (FIG. 1(b)), [29] an intermediate polymer PDMS gel is used instead of directly placing the same scotch tape with exfoliated flakes onto the substrate. Afterwards, we place the tape in direct contact with the PDMS gel and peel off the tape rapidly. The flakes adhered to the gel and the gel was placed onto a glass slide. On the other hand, the glass slide with the gel was attached to the three-axis micromanipulator stage and placed near a three-axis micromanipulator stage holding the substrate as shown in FIG. 1(b). Since the PDMS gel is transparent, the axis of micromanipulators of the desired flake can be directly placed over the target area on the substrate of our choice easily using a microscope. This transfer method relies on the viscoelastic properties of the PDMS stamp where the gel is peeled off slowly from the substrate. This allows the flakes to adhere to the substrate rather than the gel because the strength of adhesion is dependent on the speed at which the gel is pulled. [29], [33] This transfer method is advantageous because a flake can be precisely placed; however, it is not ideal considering that not only the desired flake will be transferred since the flat core slide is pressed onto the substrate in its entirety. Thus, a non-finite probability exists that some other flakes are transferred FIG. 2(b). In dry transfer and the direct transfer, we basically create the imprint of the source. Theoretically, dry transfer can also lead to cross-contamination free transfer if we have a single flake source however in reality scotch tape exfoliation results in flake clustering, which makes it difficult to find an isolated flake.

In order to decrease this random cross-contamination further, the third transfer method, i.e. Litho-Assisted approach (FIG. 1(c)) has been tested. Here, the transfer method requires the substrates to be coated with polymethylmethacrylate (PMMA) and an opening developed on a desired location using electron beam lithography (EBL) as shown in FIG. 1(c). Theoretically, after the flakes have been transferred, flakes will remain inside the target area within the box as well as randomly distributed on top of the PMMA. Upon washing off the PMMA (i.e. Acetone rinse) the access 2D flakes residing on the polymer are taking off as well, and thus this step resembles a lift-off process.

Next, we quantitatively compare the cross-contamination (CC) of the different transfer approaches in FIGS. 2(a)-(c). The highest amount of cross-contamination is for the Direct transfer as there is no controlled placement used (e.g. μ̅=50%, f=100×), FIGS. 2(a), 3(d). In addition, we observe a wide distribution in the cross-contamination histogram signifying the randomness of this approach (standard deviation=σ=35%). This method also leaves much residue from the tape on the substrate, which is undesired. However, the Dry Transfer method shows a narrower distribution (e.g. μ̅=28%, σ=8%, f=100×), FIGS. 2(b), 3(d), due to the ability to select a region of the PDMS/cover slide. In addition, since the entire centimeter-large cover slide touches the substrate, a non-finite probability exist that other structures or sensitive device regions are either contaminated or physically damaged during the transfer.

In contrast, we observe a significant improvement when using the PMMA coated substrate with electron beam lithography (EBL) pre-transfer fabricated openings (i.e. Litho-Assisted method) in FIG. 2(c). This ensures that any unwanted flakes on the gel are not transferred to the substrate directly as blocked by the PMMA coating. Although varying amounts of cross-contamination persist, this process is an improvement over the dry transfer by a factor of 15 defined as the FIGS. 2(c), 3(d). For areas larger than 100× of the flake area, the cross-contamination improves by a factor 22 shown in FIG. 3(d). This method is an improvement over the Dry transfer method due to the PMMA greatly reducing the cross-contamination.

Nonetheless, this method is not holistically viable since PMMA could damage a chemically-sensitive device. Additionally, trying to stamp on multiple openings on the same device poses a problem because there is a chance that flakes will transfer in adjacent openings rather than only the desired opening.

Thus, FIG. 2 shows the quantitative data and analysis of the cross-contamination (CC, see Eqn. (1)) on the substrate for each transfer method. In order to normalize our approach for varying 2D flake sizes, for each of the four transfer options investigated our methodology is as follow; (i) the size of the flake that is transferred into the target area (A_{flake}) is measured, (ii) the area box (A_{box}) in which cross-contamination is measured is taken as factors (f=100×, 400×, and 900×) times that of the transferred flake area (i.e. A_{box}=f×A_{flake}), and (iii) 10 flakes are transferred for each of the four transfer methods and a histogram is created along with a representative optical microscope image FIGS. 2(a)-2(c) (and for FIG. 3(c)). FIG. 3(d) shows fitting the CC histograms with a normal distribution we obtain the mean (data point) and standard deviation (error bar) for all four methods. The shaded region corresponds to the three selected factors, f Our results show that for small areas near the transferred flake (e.g. f=100×) the cross-contamination is about 30% and more than 50% for the Dry and Direct methods, respectively. In contrast CC is vanishing for the 2D Printer method and independent of A_{box}. The decline in CC (including its error) for the Direct and Dry methods is understood as a result of spatial-clustering introduced when obtaining a 2D material PDMS source (e.g. exfoliation was used).

### SUMMARY OF THE INVENTION

The invention provides a 2D printer (2D Printer). A micro-stamper is used to pinpoint the exact location the flake is to be transferred onto the substrate. A PDMS gel is placed directly over the substrate at a distance and only the part with the flake comes into contact with the substrate by bringing the micro-stamper down to transfer the desired flake within the targeted area.

Thus, a PDMS gel is stretched over the substrate and a flake is lined up with the target area. A micro-stamper is used to bend the PDMS to push the flake underneath onto the target area. This gives the same alignment precision as the Dry transfer, which determined by the overlay accuracy of the micro-stamper, 2D material and substrate. Only one single flake is transferred exactly to the target area. Using an intermediate polymer (PDMS) along with a micro-stamper pertain to a significantly reduced cross-contamination rate.

The 2D Printer reduces cross-contamination most significantly in FIGS. 3(c), 3(d). This method shows a virtually cross-contamination-free transfer by two orders of magnitude from the Dry transfer in FIG. 3(c). This is surprising as we expect the spatial accuracy for the Litho-assisted and micro-stamper-based 2D printer method to be similar.

Thus, a novel system and method is provided to transfer a precisely placed 2D material onto an arbitrary substrate with vanishing (<99%) cross-contamination up to ˜10's of μm which is well beyond the current state of the art transfer methods. To show the added advantages of this method, we next compare three currently used approaches, that are simple to replicate and do not involve heating to our new one; these comparisons are the Direct [28], Dry [29], and the Litho-Assisted, and our micro-stamper-based method, termed here ‘2D-Printer’ method. Using the latter, 2D materials can be time-efficiently placed on various electronic devices using the 2D material printer within a virtually zero cross-contamination range. We describe methodology on to industrialize the printer with rapid optical identification technique [30]-[32] and machine learning to increase scalability for various practical applications.

Here, we demonstrate a novel method of transferring 2D materials resembling the functionality known from printing; utilizing a combination of a sharp micro-stamper and viscoelastic polymer, we show precise placement of individual 2D materials resulting in vanishing cross-contamination to the substrate. The present invention 2D printer-method results in an aerial cross-contamination improvement of two to three orders of magnitude relative to state-of-the-art transfer methods from a source of average area for single flake (˜50 μm2). Moreover, we find that the 2D material quality is preserved in this transfer method. For the 2D material printer on taped-out integrated Silicon photonic chips, the micro-stamper stamping transfer does not physically harm the underneath Silicon nanophotonic structures such as waveguides or micro-ring resonators receiving the 2D material. We further demonstrate functional devices such as Graphene tunnel junctions and transistors, and TMD-based material tunable microring resonators. Such accurate and substrate-benign transfer method for 2D materials could be industrialized for rapid device prototyping due to its high time-reduction, accuracy, and contamination-free process.

The 2D printer technique overcomes the issues with the prior art techniques of FIG. 1. Upfront, without the need for a PMMA substrate coating, it encompasses the full range of devices as well as a reduction in cross-contamination. For instance, the mean ratio of the 2D printer vs. Direct and Dry methods for the smallest test region are 310 and 170 respectively. The randomness of the latter two methods is somewhat mitigated when the box is increased, which can be explained by a 2D materials source (PDMS) clustering effect from originated from exfoliation. Thus, this is not intrinsic to the 2D Printer method, and would be e.g. higher if CVD grown patches of 2D material flakes would be used as a source instead.

For Device fabrications, Ti (10 nm)/Au (40 nm) contact pads with different Channel length were fabricated using Electron beam lithography and E-beam evaporator on Si/SiO₂ (50 nm) substrate. Graphene is exfoliated using scotch tape exfoliation method and is transferred to PDMS. PDMS is observed under the microscope for different desired flake sizes to align flakes accurately for different channel widths by using 2D printer methods. This way, the entire chip can be printed rapidly without any cross-contamination.

For waveguide measurement, the propagation loss of a Si waveguide has been measured by transferring 2D layered materials (hBN) multiple times to demonstrate any possibility of damage caused by 2D printer method. Light from a Tunable laser source (Agilent 81950A) is injected into the grating coupler on the TM mode for the waveguide. The light output from the chip is coupled to the output fiber by a grating coupler, and detected by the photo-receiver after each transfer.

These and other objects of the invention, as well as many of the intended advantages thereof, will become more readily apparent when reference is made to the following description, taken in conjunction with the accompanying drawings.

### BRIEF DESCRIPTION OF THE FIGURES

FIG. 1(a) illustrates a prior art Direct transfer technique;

FIG. 1(b) illustrates a prior art Dry transfer technique;

FIG. 1(c) illustrates a Lithography assisted transfer technique;

FIG. 2(a) is a graph and picture showing the transferred flakes for the Direct technique of FIG. 1(a);

FIG. 2(b) is a graph and picture showing the transferred flakes for the Dry technique of FIG. 1(b);

FIG. 2(c) is a graph and picture showing the transferred flakes for the Lithography technique of FIG. 1(c);

FIG. 3(a) shows a 2D Printer stamper in accordance with one embodiment of the invention;

FIG. 3(b) is a detailed view of the distal end of the stamper and the transfer material;

FIG. 3(c) is a graph and picture showing the transferred flakes for the 2D Printer of FIG. 3(c);

FIG. 3(d) is a graph comparing the prior art and invention contamination;

FIG. 4 is a system of the 2D printer;

FIG. 5 is a Raman spectroscopy graph of before and after transfer;

FIG. 6 shows accurate placement of flakes;

FIG. 7 shows another result of the 2D Printer;

FIG. 8(a) shows a 5×2 dense array of graphene FETs is shown on slot waveguides;

FIG. 8(b) is a graph showing transfer characteristics;

FIG. 8(c) is a graph showing typical I-V characteristics of graphene/Al₂O₃/graphene tunnel junction;

FIG. 8(d) is transfer a flake onto a ring resonator according to the prior art Direct Transfer technique;

FIG. 8(e) shows the precise transfer of a single flake onto a ring resonator in accordance with the present invention;

FIG. 8(f) is a graph showing the transmission spectrum with resonance shift after transfer of TMDCs;

FIG. 9(a) shows the robust, precise, and reliable 2DMTS, the simplified 2D transfer system platform schematic includes the microscope, linear stages for alignment movement of PDMS holder, micro-stamper, and target substrate, PDMS holder mount clips and, a close view of the micro-stamper mounted on the setup;

FIG. 9(b) is a schematic of the PDMS, micro-stamper, and target chip position under alignment highlighting the close view of stretched PDMS when the micro-stamper is approaching the targeted structure on the chip, and the inset shows the 2D material flake precisely positioned under the tip while the other flakes on the PDMS remain on the non-contact regions of the PDMS on the holder; the magnified view shows the small area of PDMS (largest reported here, ˜400×200 μm²) under the stamper with the flake underneath touching the target;

FIG. 9(c) is a side angled image of the PDMS holder mounted on the stage with a PDMS strip mounted on it; the PDMS film is positioned over the target substrate and the micro-stamper is then adjusted on top of the selected flake as seen in the image;

FIGS. 9(d), 9(e) show the modified transfer process of 2D materials on PDMS using the adhesive tape exfoliation method helps to reduce the density of overlapping flakes and provides isolated flakes on PDMS for precisely locating flakes under the microscope; this allows selective transfer of the desired flake without cross-contamination on the chip;

FIG. 10(a) shows a 2D printer setup performance analysis for accuracy, precision, and reliability test;

FIGS. 10(a)-10(c) show the distribution of position of flakes transferred on the SiO₂ substrate measured from the center of the target; the offset produced due to optics and the size of the micro-stamper can be observed in the graph; the inset shows the schematic representation of the micro-stamper size and shapes on top of the PDMS;

FIG. 10(d) is a histogram fitted with a Gaussian curve that illustrates standard deviation of the transferring process for each micro-stamper size; the graph also represents the offset in the target location due to optics and stamper size;

FIG. 10(e) is a standard deviation distribution of the flake transfer position on the target measured considering the center of the flake to the software crosshair; each band has 1 standard deviation, and the labels indicate the approximate proportion of area (note: these add up to 99.8% of data, and not 100% of data because of rounding for presentation);

FIG. 10(f), the accuracy and precision values with error bars are computed for each stamper showing high accuracy for a small stamper size and a reduced accuracy and precision for a large stamper size;

FIG. 10(g), maximum size of flakes that can be transferred with the three sizes of stamper, and the inset microscope image represents the effective area of stamping for each stamper;

FIGS. 10(a)-10(c) inset 10(h), shows the false-colored elliptical part highlights the stamping area where the scale bar is 200 μm as the stamper shape is elongated in one direction; the probability distribution of transfer success and failure rate of the transfer system was calculated by gathering 40 data sets by transferring different flakes in a different location;

FIG. 10(i) is a microscope image of the transferred MoS₂ flake on oxide substrate with PDMS residue (I) and after the cleaning process showing the residue-free area (II). The flake area after the transfer (III) and residue free area after the cleaning process (IV) is confirmed by darkfield microscopy;

FIGS. 11(a)-(h) are transfer results from the 2D material transfer system. (a)-(f) Optical microscope images for 2D graphene flake on PDMS (before transfer), a substrate with flake after the transfer, and of PDMS (after transfer) captured while using the 2D printer setup. The images verify no cracking, wrinkles, or folding of the flake after transfer on the substrate. (g) Optical microscope image of the exfoliated monolayer to few layers graphene flakes on PDMS. (h) Atomic force microscopy (AFM) mapping of the monolayer graphene flake after transfer on the SiO2/Si substrate using 2DMTS and cleaning. The mapping clearly shows no residues of PDMS on the surface and the thickness of the material in the inset graph;

FIG. 12 is a step-by-step pictorial flow chart for PDMS holder preparation and modified exfoliation technique; the holder can be reused once prepared by replacing the PDMS film clamped in between the glass slide frame; the preparation of the holder requires thin glass slides (˜1.2 mm), gel-pak thin PDMS film (17 mil), double-sided and single-sided adhesive tapes, pair of tweezers, weak adhesion exfoliation tape, ruler, and 2D material crystal; the figure in the center shows the placement of the holder on the stage for finding and positioning the 2D material flakes;

FIG. 13 shows real-time video frames acquired during the transfer of WSe₂ flakes onto a silicon micro ring resonator (MRR) structure;

FIGS. 14(a), (b) show an electronic resistivity test of 2D flakes transferred with 2DMTS. (a) Two-terminal resistance measurement of individual MoS2 flakes represented in the microscope image was performed to determine gauge length-based sheet resistance of the material for electrical characterization. A microscope image of the device in the inset of MoS₂ flake transferred on SiO2 substrate after designing the contacts for various gauge lengths. (b) Comparative study for achieving repeatable electrical properties can be observed in the form of contact resistance (R_{C} less than about 50 kΩ) and sheet resistance (R_{S} less than about 10 kΩ/sq) for 18 devices;

FIGS. 15(a)-(e) show a 2DMTS performance test for repeatability and robustness on assembling 2D structures atop photonic integrated circuit waveguides. (a) Optical microscope images at 20× magnification of MoS₂ flakes transferred on Si-MRR devices in an array on-chip separated by 200 nm distance from each other. Zoomed in at 50× magnification to show the flake position on devices. Silicon micro-ring resonator post-coupling enhancement using MoS₂ thin flakes. (b) Schematic (c) optical microscope image of an MRR (D¼80 lm and W¼500 nm) covered by two MoS₂ flakes precisely transferred using our developed 2D printer technique. (d) Spectral transmission output before and after the transfer of MoS₂ shows improvement of coupling efficiency. The improved resonance fringes can be observed in the graph. (e) Resonance peak shift and optical loss after transfer of each flake can be observed showing linear absorption loss and variation in peak shift of resonance;

FIGS. 16(a)-(f) show a Si-MRR integrated strain engineered MoTe2 photodetector. (a) Schematic representation of MoTe₂ based integrated photodetector for strainoptronics application built using the 2DMTS (b) the structure of Si-MRR [radius (r)=40 μm, height (h)=220 nm, width (w)=500 nm], and electrical contacts are represented in the optical microscope image. (c) The I-V characteristics show the enhancement in current under the illumination of light coupled through Si-MRR at 1550 nm wavelength. (d) SEM image shows the coverage of flake on one of the Si-MRR device showing the coverage of the flake on the devices (e) performance of five different photodetector devices represented by responsivity measured at zero bias (0 V), 1, and 2 V showing enhancement in magnitude due to improvement in photogenerated carrier collection under influence of bias. (f) Various photodetector devices are tabulated for understanding the bandwidth performance of MoTe₂ based photodetectors;

FIGS. 17(a)-(f) show strain-induced in multilayer WSe₂ using triangular nanopillars. (a) Schematic representation of strained multilayer WSe₂ membrane on triangular nanopillars. (b) Optical microscope images for (I) SiN triangular nanopillar structures (II) WSe₂ membrane (after transfer) using the 2D printer setup on the nanopillars. (c) Schematic representation of E¹_{2g} and A_{1g} Raman active modes of WSe₂. (d) PL spectra of WSe₂ membrane showing the fitted curve highlighting the significant active peaks. (e) Raman spectra showing the active modes (λ_{excitation}=532 nm). (f) Optical image of mapping area highlighted with the grid selection for Raman and PL mapping points (I), Raman intensity map for the strained area of the WSe2 membrane at A1g mode (II), and E1 2g mode (III). (g) PL mapping realized at significant PL peaks for WSe₂ at 680, 796, and 916 nm showing intensity enhancement for 680 and 796 nm peak position while a reduction in intensity at 916 nm peak position;

FIGS. 18(a), (b) show MoS₂ and WSe₂ multilayer heterostructure. (a) Optical microscope image of the MoS₂/WSe₂ heterostructure built on the SiO₂ substrate. The inset shows the dark-field microscopy image of the heterostructure indicating no residues on the surface of the materials and substrate. (b) Raman spectra for MoS₂, WSe₂, and MoS₂/WSe₂ heterostructure show the combined Raman signature of MoS₂ and WSe₂ at the junction formed by them.

FIGS. 19(a)-(d) show a 2D pn-junction heterostructure-based photodetector using 2DMTS. (a) Schematic representation of the pn junction device. (b) Optical microscope image for 2D heterostructure stack of p- and n-doped InSe flake on SiO₂ substrate transferred on Au/Ti metal electrodes using the transfer system. (c) I-V characteristics of the device were tested at different optical power illumination at 980 nm for photocurrent mapping. (d) The spectral responsivity of the pn junction device compared with control sample devices with n- and p-doped channel photodetectors showing enhancement of about 3.0298×. The inset shows the PL emission spectra intensity enhancement at the pn junction area compared to p and n regions.

### DETAILED DESCRIPTION OF THE PREFERRED EMBODIMENTS

In describing the illustrative, non-limiting preferred embodiments of the invention illustrated in the drawings, specific terminology will be resorted to for the sake of clarity. However, the invention is not intended to be limited to the specific terms so selected, and it is to be understood that each specific term includes all technical equivalents that operate in similar manner to accomplish a similar purpose. Several preferred embodiments of the invention are described for illustrative purposes, it being understood that the invention may be embodied in other forms not specifically shown in the drawings.

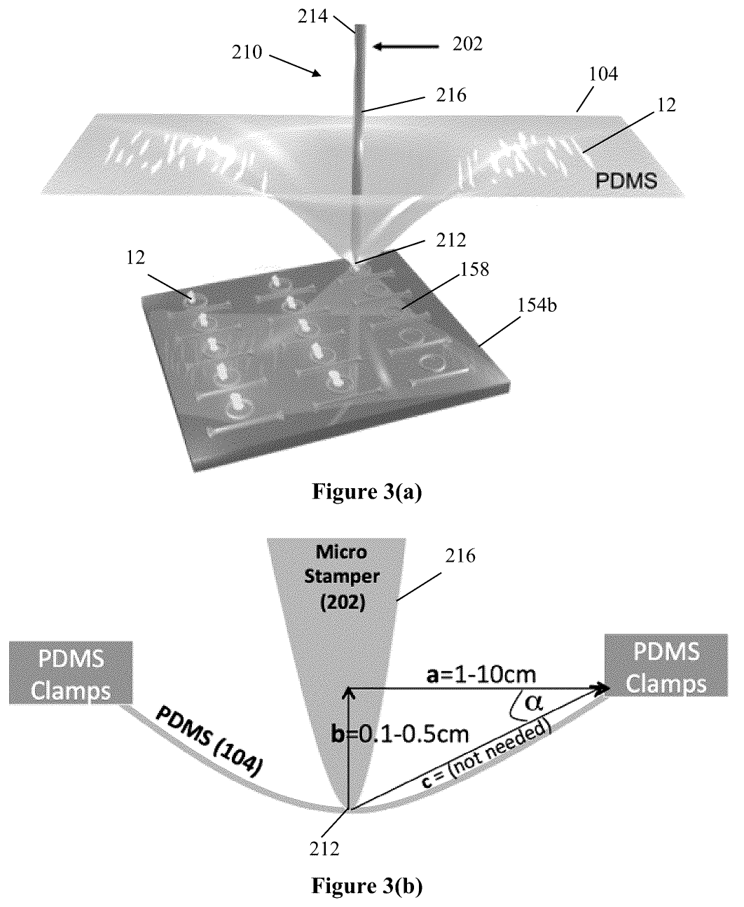

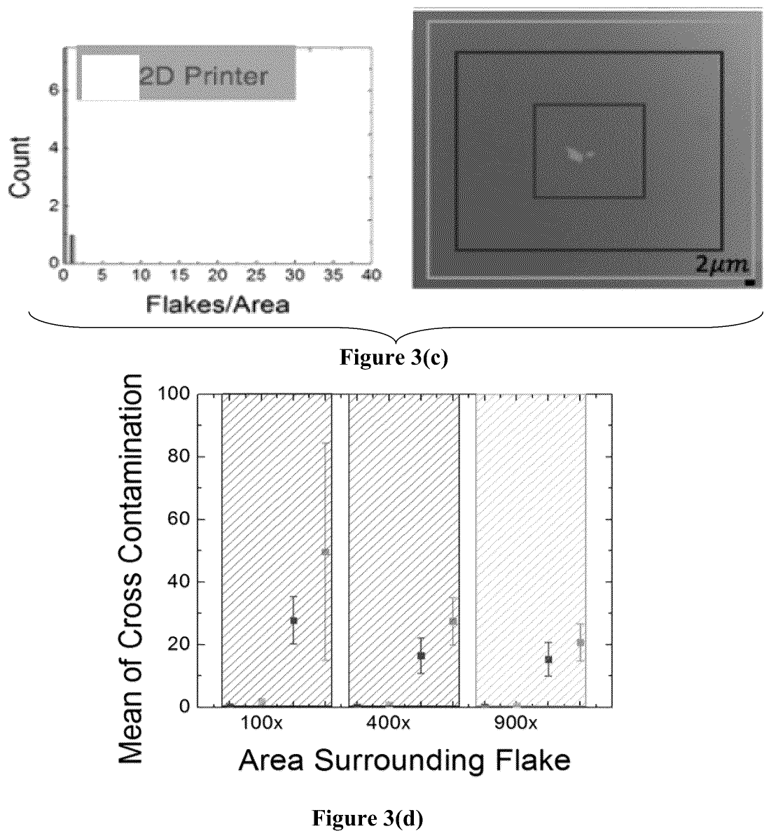

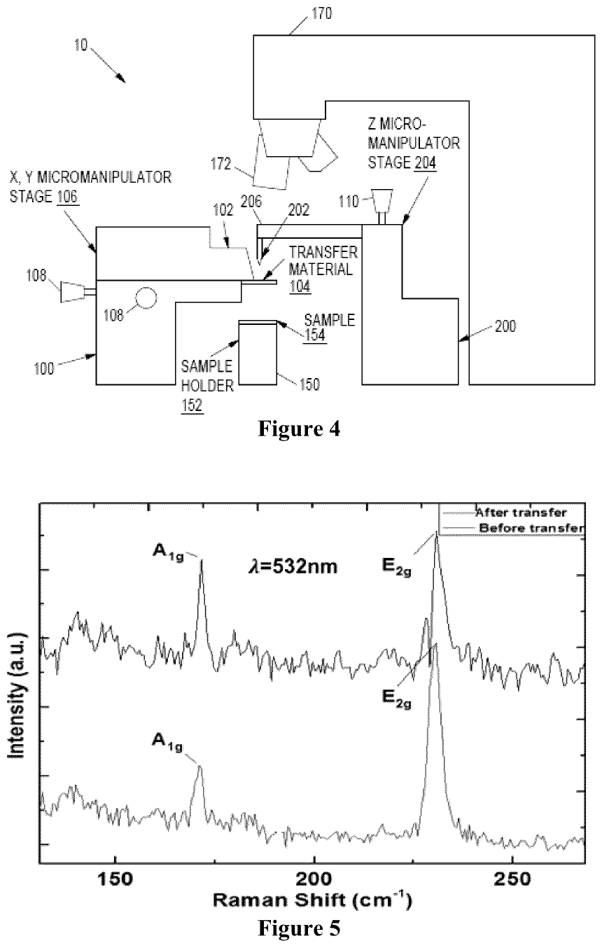

Referring to FIGS. 3(a), 3(b), 4, the two-dimensional printing system 10 is shown in accordance with a non-limiting example of the invention. Turning first to FIG. 4, the system 10 includes a transfer apparatus 100 such as PDMS apparatus, a sample apparatus 150, an imaging device 170 such as an automated or manual microscope, and a stamping apparatus 200. The sample apparatus 150 has a sample holder 152 that holds or retains one or more samples 154. The sample 154 can be, for example, a transferring substrate 154a having target 2-dimensional (2D) material to be transferred. Here, the term 2D material is generally used to refer to flakes, 2-dimensional material films, or multiple layered materials, or hetero-layers comprised of such 2D films (partial portions of those films ‘flakes’ or the entirety of the film). The sample 154 can also be, for example, a receiving substrate 154b to which the target flakes are to be placed or received in a target area 158. The sample holder 152 can hold both the transferring substrate 154a and the receiving substrate 154b, or separate sample apparatus 150 can be provided, one for the transfer substrate 154a and one for the receiving substrate 154b.

The sample apparatus 150 can also include a positioner such as a micromanipulator 156 that is coupled to and moves the sample holder 152 so that either the transferring sample or the receiving sample is aligned with the transferring apparatus 100 and the stamping apparatus 200. For example, the manipulator can be a conveyor belt that moves in a single direction, or a plate that moves in both x- and y-directions. The sample can have any suitable size and shape, such as for example a square or a rectangle up to 10 inches. In one embodiment, the sample 154 is flat and has a flat top surface that forms a plane that is substantially horizontal.

The transferring apparatus 100 includes a transfer material holder 102 that holds or retains a transfer material 104, and a positioner such as a micromanipulator 106. The transfer apparatus 100 can also include a micromanipulator stage 106 that is coupled to the holder 102. The micromanipulator 106 can move the transfer material 104 in an x- and y-direction to align with the microscope 170, stamper assembly 200 and/or sample apparatus 150. As shown, the transfer material 104 is positioned between the sample 154 and the transfer-stamper 202 of the stamping apparatus 200. The transfer-stamper 202 can be, for example, a micro-stamper or a macro-stamper, or other transfer mechanism, but is generally referred to below as a micro-stamper.

The transfer material 104 is suitable to transfer (pick up and release) a flake to which the transfer material 104 is pressed. In one non-limiting example embodiment of the invention, the transfer material 104 can be a PDMS gel. The thicker the transfer material 104, the lower the transfer resolution, but the more stable. The transfer material 104 can have any suitable size and shape, such as for example a square or a rectangle. The transfer material 104 has a resting position (FIG. 4) which in one embodiment is flat and lies in a plane that is substantially parallel to the plane of the sample material 154, both of which are substantially horizontal in the embodiments of FIGS. 3(a), 4. The transfer material 104 is aligned with the sample 154 is and spaced apart from the sample 154 by a distance of approximately 1-5 mm, though other suitable distances can be utilized. The lower the distance, than the transfer material will be able to more reliably transfer the flake, but this could result in a wider surface-contact which could impact cleanness of the transfer especially if the transfer substrate is dense with flakes. In one example embodiment, for 10 um and greater close transfers, a 1 mm distance can be used.

The microscope 170 has a long distance working objective 172. The microscope 170 enables a user or machine to view the flakes on the sample or substrate 154, and also to align the transfer material 104 and micro-stamper 202 with the target (flake to be transferred and/or the desired position for the flakes) on the sample 154. As shown in FIG. 4, the microscope objective 172 is positioned above and aligned with the micro-stamper 202, which in turn is positioned above and aligned with the transfer material 104, which in turn is positioned above and aligned with the sample 154.

The stamping apparatus 200 includes a micro-stamper 202, a positioner such as a micromanipulator stage 204, and an arm 206. As best shown in FIG. 3(a), the micro-stamper 202 is an elongated rod having a body 210 with a distal end 212, proximal end 214 and an intermediate portion 216. The proximal end 214 and the intermediate portion 216 can have any suitable cross-sectional shape such as a circle, square or rectangle. The stamper 202 is sufficiently long so that it can be extended from the support arm 206, to the transfer material 104 and depress the transfer material 104 to extend to touch the top surface of the sample 154. The distal end 212 of the stamper 202 refers to the extreme end face of the stamper body 210, and can also be referred to here as the distal end face 212. The distal end 212 can have any suitable shape for its cross-section and the extreme end face, though in one embodiment is circular, oval, or rectangular. In one embodiment of the invention, the distal end 212 is completely flat and void of any bumps or projections, so that the distal end 212 causes the transfer material 104 to reliably contact the entirety of the flake 12 to be transferred. The distal end is slightly larger than the flakes to be transferred by the transfer material 104, and in one embodiment has a size of few (2-10 um) to 100-300 um, though can be larger (on the order of millimeters or centimeters) for large films. The size of the distal end can depend on the distance that the transfer material must move, so that the stamper does not punch through the transfer material. In yet another example embodiment of the invention, the edges of the distal end can be curved (FIG. 3(b)) so that avoid puncturing the PDMS material 104.

As further illustrated in FIGS. 3(a), 4, the stamper 202 has a longitudinal axis that is substantially orthogonal to the plane of the transfer material 104 and the plane of the sample 154. And the support arm 206 is an elongated member that extends outward from the micromanipulator stage 204 and connects to the micro-stamper 202. The support arm 206 can be part of the micromanipulator stage 204. The stamp micromanipulator stage 204 moves the support arm 206 in a z-direction to position the micro-stamper 202 with respect to the transfer material 104 and substrate 154. Thus, the micromanipulator stage 204 can also raise and lower the support arm 206 to move the micro-stamper 202 toward and away from the transfer material 104 and sample 154 (up/down in the embodiment of FIGS. 3(a) and 4. Thus, even if the stamper 202 is not elongated and does not have a longitudinal axis, the stamper 202 moves in a direction that is substantially orthogonal to the plane of the transfer material 104 and the plane of the sample 154. In one example embodiment, the micro-stamper 202 can be raised and lowered manually by use of a knob 110, or can be controlled automatically, such as by a motor.

Thus, the 2D printer has a two-axis (x- and y-directions) stage micromanipulator 106 holding the PDMS holder 102 in FIG. 4, which in turn holds the PDMS material 104. The PDMS holder 102 can be controlled manually by use of knobs 108, or can be controlled automatically, such as by a motor. The manipulator 106 can be three-axis (x-, y-, and z-directions) to raise and lower the PDMS holder 102 before and/or after transfer of the flake. The micromanipulator holds clips responsible for holding the thin transfer material 104, which can be a PDMS gel. Another three-axis (x-, y- and z-directions) micromanipulator 204 is used to control the micro-stamper. And a three-axis (x-, y-, and rotation) micromanipulator 156 can be utilized to move the sample 154. The manipulator 156 can also move up/down, if needed before and/or after the flake transfer.

As described, micromanipulators 156, 106, 204 are utilized because the micro-stamper placement must be very precise since a slight shift of a few micrometers could drastically change the flake alignment. Thus, the manipulators can perhaps be adjusted to less than 10 nm so that the flakes can be transferred with that accuracy, though up to 10 micrometers adjustment can also be provided. While improved equipment such as high magnification microscope objective lenses with (ideally) long working distance and nanometer or micrometer precision mechanical components yield better overlap accuracy, the setup used in this work has a lateral transfer resolution of about ±5 μm, mainly limited by mechanical precision and optical resolution. The latter sets a bound given by the long-required working distance of the objective lens. In addition, it is necessary to consider the size of the flake being transferred. If a flake is smaller than the micro-stamper 202, the flake will transfer 100% of the time because the entire surface area of the flake touches the substrate. On the other hand, if a flake is larger than the micro-stamper 202, the flake will not transfer reliably. In this case, either a part of large flake will transfer or there will be no transfer at all due to the multilayer nature.

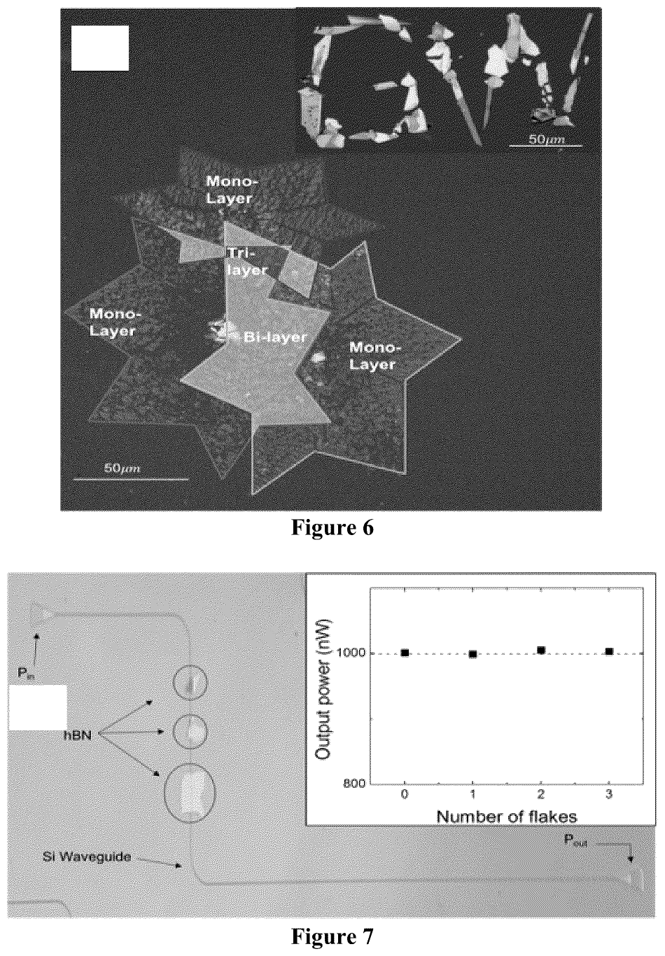

Since the micro-stamper 202 and the PDMS 104 are key factors in reducing cross-contamination, testing is further done to ensure accuracy when the experiment is reproduced, we find that when the micro-stamper is in contact with the substrate, the PDMS acts as a shock absorber, preventing any possible damage to the device. Raman measurements have been performed to investigate the quality of the 2D flakes before and after the transfer process as depicted in FIG. 5. Looking at the spectra for both before and after transfer, the peaks rise (A_{1g}=171.11, E_{1g}=230.64) at the same point ensuring that the material's identity has not been affected in this transfer process. We have demonstrated thickness controlled transfer process by using our method as presented in FIG. 6. Three monolayers flakes have been transferred successively on top of each other with precise alignment providing immense opportunity in terms of device functionality as discussed later. Due to the precision placement and cross-contamination-free essence of this method, it can be applied for the creation of multiple, quick and accurate heterostructures on the same chip. FIG. 7 presents the integration of h-BN on Si waveguide by our 2D printer method to demonstrate damage-free transfer. That is, we have transferred several h-BN layers on a Silicon waveguide multiple times and measured the propagation loss after each transfer (see inset to FIG. 7). The measured waveguide output power remains unchanged, just limited by the noise.

Referring to FIGS. 4-7, a schematic of the 2D printer is illustrated (FIG. 4) and described along with a Raman spectroscopy graph (FIG. 5) of the flake before and after the transfer process. FIG. 4 is a schematic diagram of the 2D printer. The setup of the 2D printer includes a micromanipulator stage 156 that rotates to align with the specific geometry of the flake as needed. The PDMS gel 104 is held above the substrate 154 with the PDMS clipped together on both sides, as shown by the clamps in FIG. 3(b). The gel 104 is stretched out until it is taut to increase the likelihood of transferring a single flake.

A micro-stamper 202 is placed over the gel 104 with an adjustable three-axis micromanipulator 204. Referring to FIG. 5, a Raman spectroscopy graph of before and after the 2D Printer transfer of a TMD flake (MoTe2) shows the preservation of the material quality upon micro-stamping using the 2D Printer 10. FIG. 6 shows the accurate placement of three monolayers of TMDs sample showing the versatility of the 2D printer 10. Printing of the letters “GW” using 2D materials demonstrates the precise alignment of flakes (see inset of FIG. 6). FIG. 7 is a demonstration of hybrid integration of three hBN being transferred onto a silicon photonic waveguide using the 2D Printer 10 showing an unchanged power output of the waveguide. This indicates that placing the 2D materials onto waveguides is a gentle method that minimizes contamination.

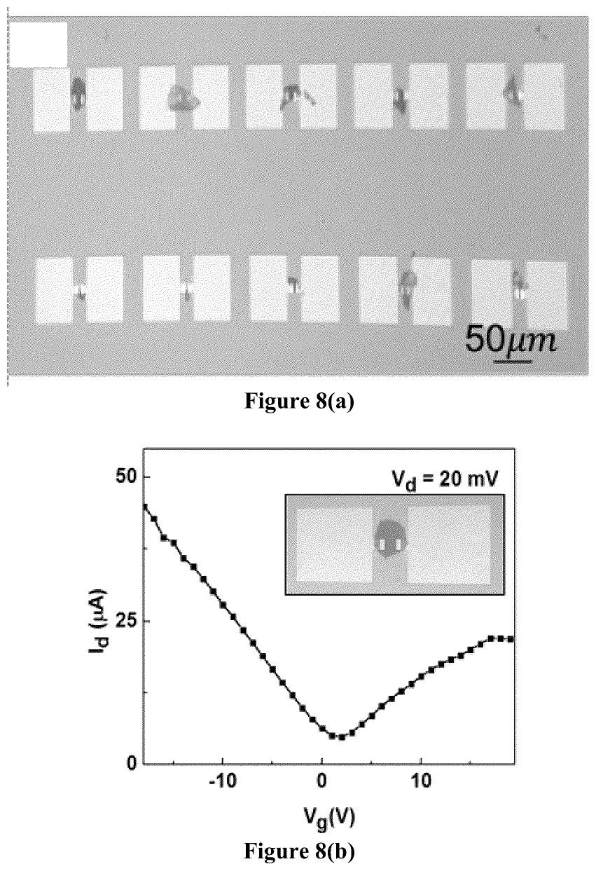

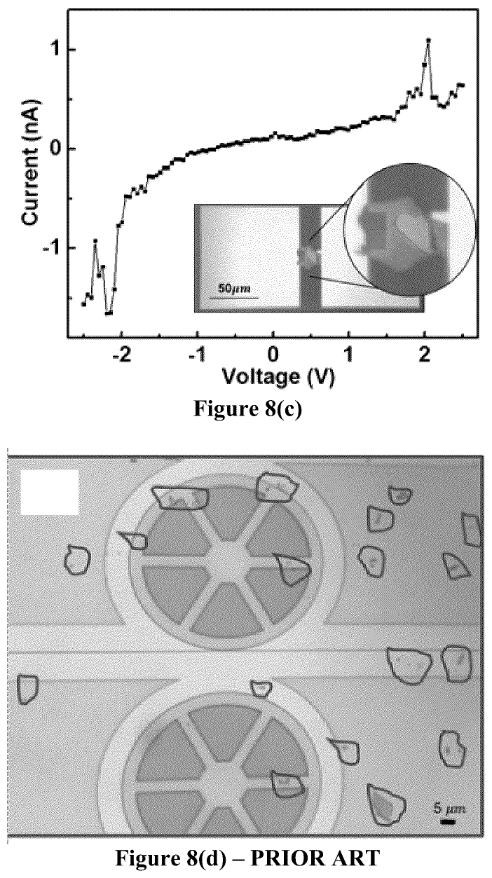

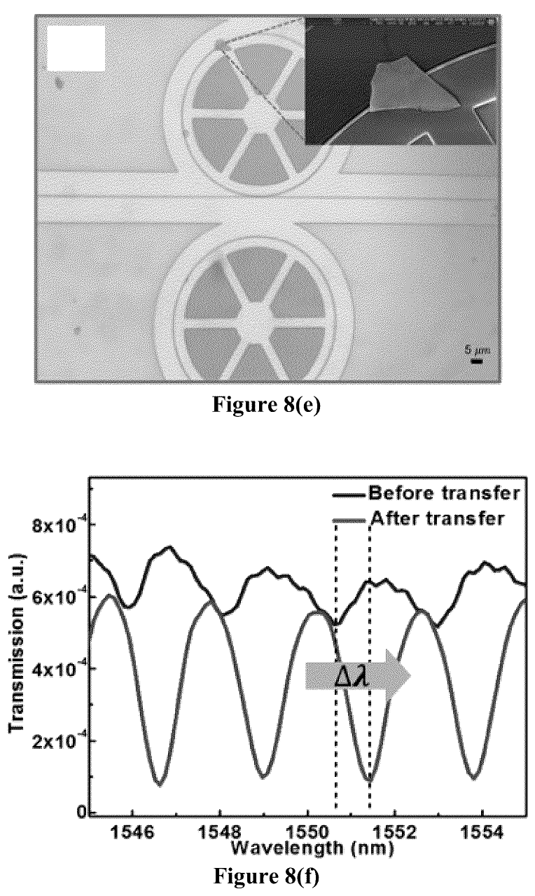

The advantages of the 2D material printer 10 are highlighted in FIG. 8 showing various practical applications. For instance, we demonstrate the capability to successfully transfer graphene on a dense array (5×2) of transistors on a silicon substrate (FIG. 8(a)). Here we find little to no cross-contamination on the device, providing the ability to have multiple stampings on the same substrate to create working devices. This is not possible with the dry transfer method for typical dense flake sources. The transfer characteristics of graphene FET devices based on this method show functional FET (FIG. 8(b)). The Dirac point obtained from the IV-curve is about 1.5 V, which suggests p-type doping anticipated from oxygen doping in ambient conditions.

FIG. 8 shows applications based demonstration of the novel 2D Printer transfer method. In FIG. 8(a), a 5×2 dense array of graphene FETs is shown on slot waveguides using the 2D Printer 10. The flakes are placed inside the boxes with no observable zero cross-contamination. Towards realizing integrated electronic or photonic devices or heterostructures can be built in this fashion as demonstrated. In FIG. 8(b), transfer characteristics are shown of the field effect transistor channeled by monolayer graphene (GFET) sweeping gate voltage (Vg) from −20 to +20 V under ambient condition at VSD=20 mV showing ambipolar nature with a Dirac point @ 1.5 V suggesting slightly p-type doped. A schematic is shown of the single back gated GFET (see inset to FIG. 8(b)).

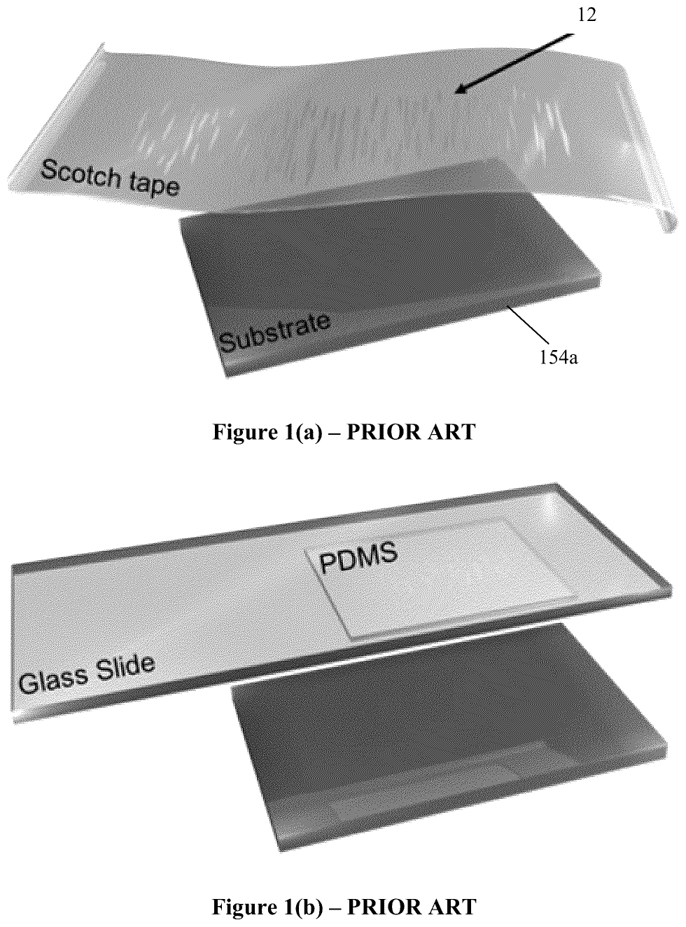

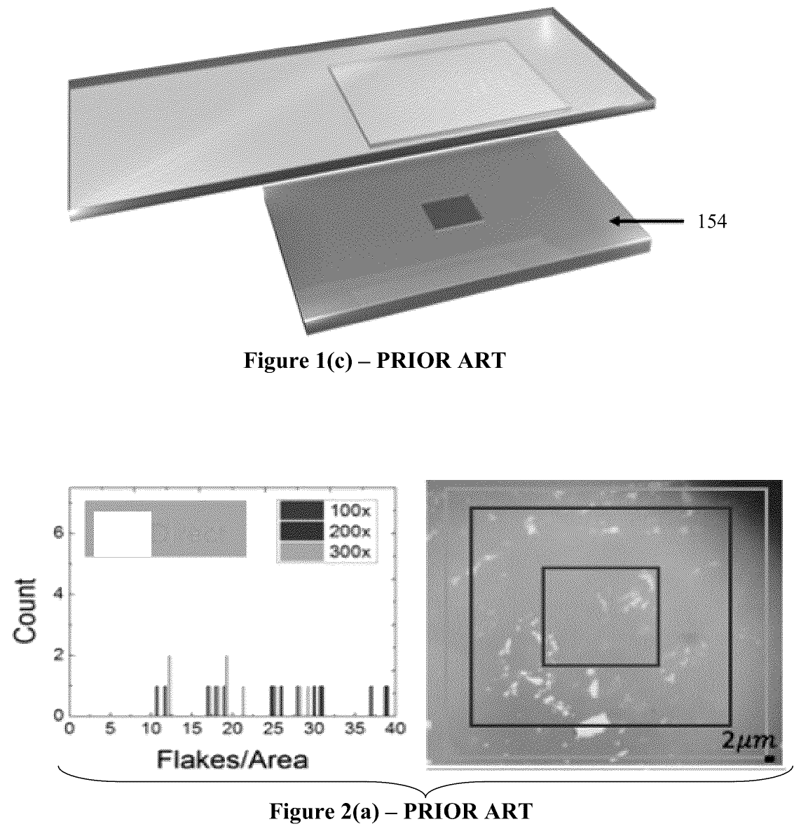

Referring to FIG. 8(c), typical I-V characteristics of graphene/Al₂O₃/graphene tunnel junction showing negative differential resistance (NDR) effect. A device schematic is shown in the inset. In FIG. 8(d), the Direct transfer method (FIG. 1(a)) is used to transfer a flake onto a ring resonator. However, the lack of selectivity of this method transfers more than the target flake, depending on the source quality. If exfoliation is used as a source, the to-be-stamped PDMS usually contains clusters of 2D materials leading to a high amount of cross-contamination potentially ruining neighboring devices or waveguides. On sensitive and costly chips (e.g. such as on tape-outs as done here using silicon photonics), this method would not be viable considering the amount of cross-contamination that is unpreventable as well as the randomized approach to get a flake 12 onto the target area 158.

In FIG. 8(e), the 2D Printer 10 is used to precisely transfer a single flake onto a ring resonator. The optical microscope image shows that the flake is successfully transferred onto a single micro ring resonator with no cross-contamination. The inset shows the SEM image of the transferred flake on the micro-ring ring resonator. FIG. 8(f) shows the transmission spectrum with resonance shift after transfer of TMDCs on top of Si micro-ring resonator resulting a change in effective refractive index of the propagated mode.

The invention successfully demonstrates functional devices using the 2D printer 10 by fabricating multiple heterostructures. The invention provides an accurate yet fast 2D printer based transfer approach. We tested this capability by fabricating Graphene-based transistor devices whose I_{d}-V_{d} characteristics of these graphene/oxide/graphene tunnel junctions (FIG. 8. 4(c)). Indeed we observe the characteristic negative-resistance behavior where the two graphene Fermi-levels facilitate electron tunneling. The precise and dense transfer functionality of the 2D printer is further exemplified by enabling heterogeneous integration of 2D materials with silicon photonics (FIGS. 8(d), (e)). We place a MoTe₂ flake onto a Si micro-ring resonator to tune its relative phase and coupling condition by changing the optical mode of the ring. We find a high-degree of cross-contamination for the Dry method (FIG. 1(a)) with flakes scattered across the silicon photonic waveguides, covering neighboring devices. This renders this method unusable for taped out Si-photonic chips.

Repeating the experiment with the 2D Printer 10 shows that only the single targeted flake is accurately placed onto the micro-ring resonator. The optical transmission before and after transfer of TMDCs shows a significant resonance shift (FIG. 8(f)). This provides an improvement of coupling and right shift (FIG. 8(f)) of resonance after the transfer of MoTe₂ layer on top of the resonator. This can be explained by a relative coupling shift (from bus to the ring) of this hybrid device towards critical coupling (r=a, where r is the self-coupling coefficient and a is the roundtrip transmission coefficient) as compared to before transferring which is over coupled (a>r). The resonance condition of the ring is given by,

$${λ}_{m} = \frac{2 π R * {n}_{eff}}{m}$$

where, λₘ resonant wavelength, m is the mode number, R is the radius of the ring and n_{eff} is the effective refractive index. From the above equation, we can obtain the following formula,

$$\frac{Δ {λ}_{m}}{{λ}_{m}} = \frac{Δ {n}_{eff}}{{n}_{eff}}$$

suggesting the redshift of resonance (Δλₘ) occurs due to the increase of effective refractive index (Δn_{eff}) after the transfer of MoTe₂ layer as indicated in FIG. 8(f).

Industrial application for Van der Waals heterostructures requires a scalable approach to stack 2D materials on top of each other and an arbitrary substrate with any morphology. The 2D Printer 10 is reliable and can be automated without any manual operation. The apparatus in FIG. 4 could be automated with a motor using a microcontroller or Raspberry Pi to rotate both stages according to user input, effectively reducing human error of misalignment. One of the major characteristics of these exfoliated flakes is a correlation between the color of the flakes taken with an optical white light microscope images versus the heights of the flakes. [30]-[32] AFM height measurement data will be taken and fed into a machine-learning algorithm to determine flake heights that were not explicitly determined. The color contrast will be calculated, and a data spreadsheet will be created corresponding the color and height variables. A user interface will ask for desired 2D material, desired flake height, desired flake size, and target area 158 for input. Such rapid optical identification algorithm make it possible to quickly locate the desired characteristics and align the two micromanipulator stages and the micro-stamper will be brought down automatically. This creates an industrial style quick, efficient, and low cross-contamination 2D material printer for use of placing 2D materials on optoelectronic devices, photonic integrated circuits, etc.

In summary, a novel transfer 2D printer 10 utilizes a micro-stamping technique to significantly reduce the lateral cross-contamination area on the substrate receiving the 2D material and improving spatial accuracy. Using a conventional micro-stamper significantly improves the transfer of multilayer and few layer 2D materials reliably reducing cross-contamination often caused by other transfer methods. Compared to the state of the art transfer methods, the 2D printer 10 shows a virtually cross-contamination-free (>99% clean) transfer methodology up to −10's of μm. This capability significantly increases the range of application of 2D materials. We also demonstrate the diversity of applications that this printer 10 and technique can perform (i.e. electronics, photonics, plasmonics, on-chip circuits, etc.) as well as showing that it does not damage these devices. Additionally, this printer 10 and technique can be easily automated by combining rapid optical identification algorithms along with simple motors. The printer can be further improved by these means of automation, reducing the human error as well as improving transfer speed. This fast and efficient method will provide a means for expedited research regarding 2D materials on optoelectronic devices, heterostructure fabrication, and more.

In one non-limiting example of the invention, the automated printer 10 can include an imaging device 170, such as having a camera or the like, instead of a microscope 170. And the imaging device 170 can have an imaging micromanipulator. Still further, one or more controllers or processing devices can be provided in communication with the imaging device 170, stamping apparatus 200, sample apparatus 150, and/or PDMS apparatus 100. The processing device can communicate with the imaging micromanipulator, stamping micromanipulator 204, PDMS micromanipulator 106 and/or the sample micro-manipulator 156 and provide respective control signals to automatically position the imaging device 170, micro-stamper 202, the PDMS material 104, and/or the sample(s) 154 to be in alignment with one another.

In an alternative embodiment, the system need only know where to place. For example, the system can utilize a CAD file with coordinates, and not use an imaging system, provided that the x, y controller and driver are closed-loop and know exactly how far they have traveled relative to an absolute coordinate system. Thus, an automated system may not necessarily need to have an imaging device, but instead can use a CAD file or have data indicating the location of the flakes. The system would have a registration system, which can include optical registration, but could also be with piezo devices in closed loop form, other otherwise.

The operation of the system 10 will now be discussed with respect to FIGS. 3(a), 4. The transfer substrate having the flake 12 to be transferred, is placed in the sample holder 152. And the transfer material (i.e., PDMS) 104 is placed in the PDMS holder 102. The imaging device 170 is then used to align the micro-stamper 202 with the PDMS 104 and the target flake 12 on the transfer substrate 154a. Since the PDMS material 104 is optically transparent, the imaging device 170 is able to optically image the micro-stamper 202 and the transfer substrate 154a, and therefore is aware of the position of the micro-stamper 202, the target flake 12, and the transfer substrate 154a (the system is aware of the location of the photonics devices on the substrate).

If necessary, the controller (i.e., processing device) sends a control signal to any of the sample or substrate micromanipulator 156, the stamper micromanipulator 204, and/or the transfer micromanipulator 106 to respectively move any one or more of the sample holder 152 (which in turn moves the transfer substrate 154a), the micro-stamper 202 (e.g., directly or by moving the support arm 206), and/or the PDMS holder 102 (which in turn moves the PDMS material 104) so that the transfer substrate 154a, micro-stamper 202 and PDMS 104 are properly aligned with each other. In this ready position, the micro-stamper 202 is aligned over the PDMS material 104, which is aligned over the transfer substrate 154a. In one non-limiting example embodiment, the micro-stamper 202 is approximately about <1 millimeter away (vertically) from the PDMS material 104, and the PDMS material 104 is approximately 1-5 millimeter from the substrate 154.

Once the printer 10 is in the ready position with the micro-stamper 202 aligned with the PDMS material 104 and the target flake 12 on the transfer substrate 154, the controller then sends a control signal to the stamper micromanipulator 204 to move the micro-stamper 202 toward the transfer material 104 and the transfer substrate 154 (downward in the embodiment of FIG. 4). The micro-stamper 202 continues moving until it comes into contact with the PDMS material 104, which can be a very small distance. It then continues to move toward the transfer substrate 154 (downward in the embodiment of FIGS. 3(b), 4). The distal end 212 of the stamper 202 stretches the PDMS gel material 104 downward until it comes into contact with the target flake 12 on the transfer substrate 154a. That distance can be relatively small, such as for example 1-5 mm, whereby the transfer material 104 is at an angle of about 1-27 degrees, as shown in FIG. 3(b). The angle of the transfer material 104 is about the angle α of the right-angled triangle a, b, c in FIG. 3(b), where:

$$tan ( α ) = \frac{b}{a} = \frac{[ 0.1 ; 0.5 ]}{[ 1 ; 10 ]} = e . g . = [ 0.01 ; 0.5 ] cm and α = [ 0.5 ; 27 ] ° .$$

As the micro-stamper 202 travels, the controller continues to monitor, utilizing output from the imaging device 170, the alignment of the micro-stamper 202 with the target flake 12, and can send one or more control signals to the stamper micromanipulator 204, the PDMS micromanipulator 106 and/or the substrate micromanipulator 156 to best align the micro-stamper 202 with the PDMS material 104 and the target flake 12 on the transfer substrate 154a. Once the PDMS material 104 contacts the target flake 12, the flake 12 is transferred from the transfer substrate 154a to the transfer material 104. More specifically, when the PDMS 104 touches the substrate 154, the flake is in contact with the PDMS 104, but the surface energy between the flake and the substrate is higher than the flake and PDMS 104, so the flake leaves the PDMS 104 when the PDMS 104 is pulled up. Any desirable force can be applied and optionally dynamically measured to ensure that the flake is reliably transferred.

At this point, the printer 10 is in the transfer position, with the distal end 212 of the stamper 202 pressing the PDMS material 104 to the transfer substrate 154. The PDMS material 104 is at the furthest stretched position. Since the PDMS material 104 is stretched, the PDMS material 104 only touches the transfer substrate 154a in a very focused area of the substrate 154 defined by the size and shape of the distal end 212 of the stamper 202. Accordingly, the size and shape of the distal end 212 is selected to be only slightly larger than the size and shape of the flakes 12 to be transferred. In this manner, the printer 10 minimizes the amount of excess material that the PDMS material 104 picks up from the transfer substrate 154a and transferred to the receiving substrate 154b, thereby minimizing contamination of the receiving substrate 154b.

Accordingly at this point, the printer 10 is in the transfer position and the flake 12 has been transferred to the transfer material 104. The controller then sends a control signal to the stamper micromanipulator 104 to move the micro-stamper 202 away from the transfer substrate 154a, for example by raising (upward in the embodiment of FIG. 4) the micro-stamper 202 slightly to a hold position. The micro-stamper 202 is raised just enough to provide a gap between the distal end 212 of the stamper 202 with the transfer material 104, and the transfer substrate 154a. In an alternative embodiment, instead of moving the micro-stamper 202 upward to the hold position, the controller can instead send a control signal to the substrate micromanipulator 156 to move the transfer substrate 154 away (i.e., downward) from the micro-stamper 202.

Once the printer 10 is in the hold position, the controller then sends a control signal to the substrate micromanipulator 156 to move the transfer substrate 154a completely away from the micro-stamper 202, and to move the receiving substrate 154b into position below the micro-stamper 202. As previously noted, the transfer substrate 154a can be at the same sample apparatus 150 as the receiving substrate 154b or the transfer substrate 154b can be at a different sample apparatus 150 than the receiving substrate 154b. In this manner, the PDMS material 104 and micro-stamper 202 remain stationary so that the flake 12 does not inadvertently come free of the PDMS material 104 and the flake 12 remains aligned with the micro-stamper 202. However, in an alternative embodiment, the transfer substrate 154a and the receiving substrate 154b can remain stationary, and the controller can send a control signal to the stamper micromanipulator 204 and the PDMS micromanipulator 106 to simultaneously move the micro-stamper 202 and PDMS material 104 from alignment with the transfer substrate 154a to alignment with the receiving substrate 154b.

At this point, the printer 10 is in the set position, with the micro-stamper 202 and the stretched PDMS material 104 aligned with the target area on the receiving substrate 154b, but slightly retracted from the receiving substrate 154b. The controller then sends a control signal to the stamper micromanipulator 204 to move the micro-stamper 202 toward (downward) the receiving substrate 154b. Accordingly, the micro-stamper 202 moves to the placement position, where the distal end 212 of the micro-stamper 202 presses the PDMS material 104 against the target area on the receiving substrate 154b, as best shown in FIG. 3(a).

In that placement position, the PDMS material 104 is at the furthest stretched position. Since the PDMS material 104 is stretched, the PDMS material 104 only touches the receive substrate 154b in a very focused area of the substrate 154b defined by the size and shape of the distal end 212 of the stamper 202. Accordingly, the size and shape of the distal end 212 is selected to be only slightly larger than the size and shape of the flakes 12 to be transferred. In this manner, the printer 10 minimizes the amount of excess material that the PDMS material 104 picks up from the transfer substrate 154a and transferred to the receiving substrate 154b, thereby minimizing contamination of the receiving substrate 154b. And, the distal end 212 can position the flake 12 in a very precise target area 158 on the receive substrate 154b.

Once the stamper 202 touches the receive substrate 154b, the flake 12 is transferred to the receive substrate 154b. The controller then sends a control signal to the stamper micromanipulator 204 to cause the micro-stamper 202 to move away from (upward in the embodiment of FIG. 4) the receive substrate 154b. At this point, the printer 10 can move to the set position where the micro-stamper 202 is slightly separated from the receive substrate 154b, but the stamper 202 still stretches the PDMS material 104. The transfer substrate 154a can then again be placed below the micro-stamper 202 and the micro-stamper 202 aligned with a new target flake 12 on the transfer substrate 154a. That will result in the same area on the PDMS material 104 being used to acquire the new target flake 12. Or, the micro-stamper 202 can move back to the ready position shown in FIG. 4, where the micro-stamper 202 does not touch the PDMS material 104. As it moves upward, the PDMS material 104 retracts and returns to its original shape. The controller can then send a control signal to the stamper micromanipulator 204 to align the micro-stamper 202 with a different and previously-unused area on the PDMS material 104, and also align the micro-stamper 202 and PDMS material 104 with the new target flake 12 on the transfer substrate 154a. The process is then repeated to acquire the new target flake 12 and transfer it from the transfer substrate 154a to the receive substrate 154b.

It is noted that the invention has been described as having multiple micromanipulators, including a stamp micromanipulator 204, PDMS micromanipulator 106, and a substrate micromanipulator 156. And, that the stamp micromanipulator 204 only moves in the z-direction (up/down), whereas the PDMS micromanipulator 106 only moves in the x-direction and the y-direction. However, only one micromanipulator can be utilized and positioned at any device or location, including the imaging device 170, stamping apparatus 200, transfer apparatus 100, or substrate apparatus 150. Or, more than one micromanipulator can be utilized at any or all of those devices or locations. Moreover, the micromanipulator can be any suitable device that can cause movement in one or more directions.

Designing novel materials to improve the quality of life is appealing, but it is also challenging in practice. The problem of integrating the best desirable qualities from various components into a single ultimate substance remains complex and unsolved. Composite materials and III-V heterostructures have revolutionized many aspects of modern technologies laying the initial milestone in the process of engineering the material properties. However, it is still challenging and complex to mix and match crystalline materials with their unique properties of forming heterostructures with controlled tunning of attributes, functionalities, and properties. Developing novel techniques for using such materials like two (2D) dimensional materials is crucial for further material characterization enabling novel technological advancements.

The mechanical exfoliation of atomically thin 2D graphene layers from its bulk crystals in 2004 introduced a unique research study of two-dimensional materials. This influenced the scientific community to investigate the fundamental graphene properties and applications in various domains. The invention of the micromechanical exfoliation method was the key to the success of graphene science, providing extremely high-quality samples and arousing curiosity for studying other 2D materials like transition metal dichalcogenides (TMDCs), MXenes, and 2D layered material-based insulators. The exfoliation process produces crystal flakes of various sizes and thicknesses that are non-uniformly (i.e., spatially and material quality) and densely distributed over the target substrate leading to a low yield of useful atomically thin flakes.

The hence required implementation of the optical identification method facilitates identifying useful atomically thin flakes on the substrate based on the contrast difference in the image for different thicknesses allowing accurate and non-contact techniques of locating the flakes. This method, however, is not suitable for fabricating complex systems such as heterogeneous integration of 2D materials on other pre-fabricated devices and structures8 or building van der Waals (vdW) heterostructures by artificially stacking different 2D material flakes. Therefore, it is important to develop new experimental setups and techniques for using 2D materials to fabricate more complex systems with enhanced reliability and functionality. Recently unique and modified techniques are developed such as the pick-and-place approach, the wedging method, the polyvinyl alcohol (PVA) method, patterned stamping method, viscoelastic stamping, patterned monolayer transfer, metal-assisted transfer, and Evalcite method for deterministic transfer of 2D materials. Each of these helps transfer 2D materials efficiently but is limited by their shortcomings and scope of implementation, such as obtaining a high yield of quality flakes, avoiding contamination of entire substrate from undesired flake transfer, demonstrating repeatability in device performance, and avoiding undesired residues on flakes.

The intrinsic properties of 2D materials are extremely sensitive to the chosen transfer and/or handling method deployed, which can involve temperature-assisted transfer, sacrificial polymer layers, litho-assisted patterned stamps, and/or wet chemical processes for substrate etching in the transfer process. The target substrate surface structures, for example, can be reactive to the chemicals used, and the capillary forces involved in the process may crack very thin layers or produce capillary action-assisted undesired strain due to bubbles or wrinkling formed under surface in suspended materials. 2D materials are also sensitive to temperature changes leading to surface oxidation of materials in a few cases. Thus, the dry transfer methods, help in overcoming wet-chemistry related challenges. Despite these modifications in improving the transfer method and system, the critical issue of spatial cross-contamination of the unwanted 2D material crystal flakes on the transfer substrate and yield of good quality flakes are yet to be addressed. An attempt of solving these issues focused on overcoming the cross-contamination challenge in a 2D material transfer system (2DMTS) by a comparison-based study. However, with increased research in the field of 2D materials, a reliable, robust, and highly repeatable method and transfer system is important for accelerating the 2D manufacturing process at free space, integrated electronic, and/or photonic chip-level, straintronics and large area optics applications.

Here, we introduce a 2D material transfer system (herein termed 2DMTS) capable of (i) eliminating contamination on 2D material-based flakes, devices, and target substrate, (ii) increasing the yield and quality of transferred material flakes, (iii) enabling rapid and accurate transfer, and (iv) achieving without involving wet chemical etching or thermal assisted process step for transfers. The 2DMTS is a one-of-a-kind transfer method using a viscoelastic polymer and metal micro transfer stamper enabling selectivity during transfer. We demonstrate a reliable, robust, and highly accurate method to transfer 2D materials onto arbitrary substrates with virtually no cross-contamination showing a high spatial accuracy of 0.7 μm which is the highest reported to date without cross-contamination. After introducing 2DMTS and experimentally validating its capability and performance limitations, we put its rapid prototyping capability to use demonstrating novel device and fabrication capacities to include building and demonstrating optoelectronic devices featuring device novelty covering the fields of photonics, arrayed structural deposition of materials, heterostructure lattices, and electronic devices, including strain optronics-based photodetector devices.

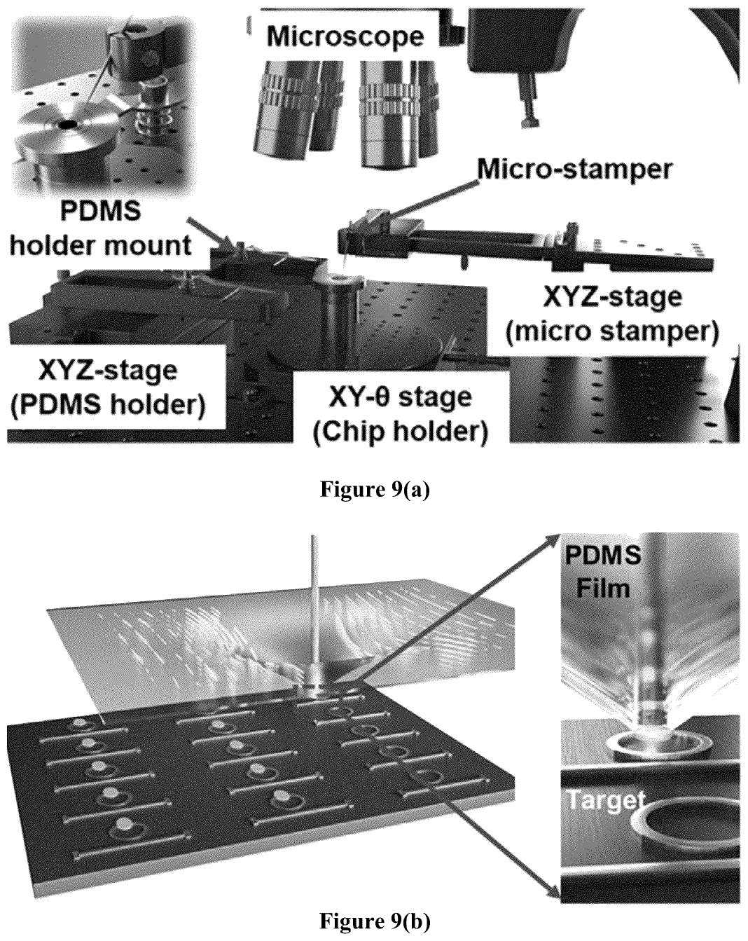

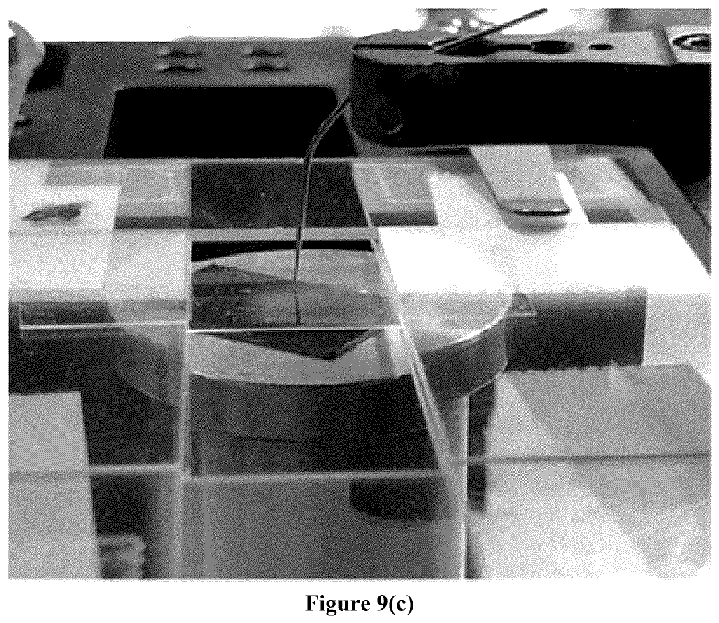

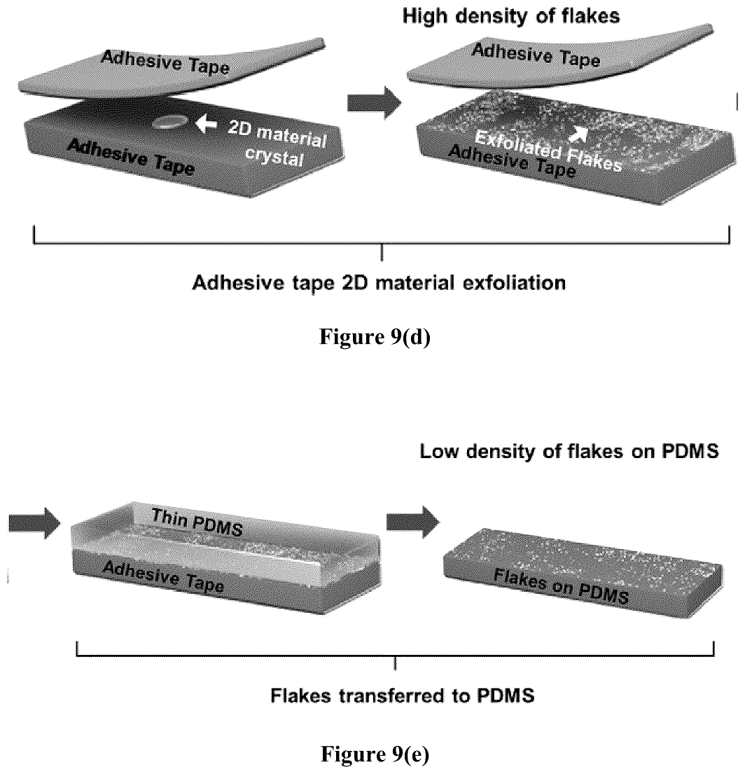

The 2D transfer system platform (2DMTS) introduced and discussed here includes a metallurgical microscope, three linear axis stages for movement of polydimethylsiloxane (PDMS) holder, a micro-transfer-stamper, and a target chip for precise alignment, FIG. 9(a). A small screw lock-based clamp needle holder is mounted on an angled arm XYZ axis stage to avoid blocking the field of view of a long working distance microscope mounted on top as seen in FIG. 9(a). The PDMS holder mount is attached to an XYZ-stage PDMS holder. The PDMS mount couples the PDMS to the PDMS holder. The PDMS holder moves the PDMS in the x-, y-, and z-directions to position the PDMS with respect to the chip or sample. A micro-stamper mount couples the micro-stamper to an XYZ-stage micro stamper holder. The micro-stamper stage moves the micro-stamper in the x-, y-, and z-directions to position the micro-stamper with respect to the PDMS and the chip or substrate. The micro-stamper has an arm that is angled with respect to the chip or sample, and with respect to the PDMS. The micro-stamper can be lowered along Z-axis carefully to touch the substrate and transfer the selected flake after alignment as seen in FIG. 9(b).

The microscope is mounted with a standard eight-bit CMOS camera. It is used for the alignment of the system and measures the size and area of the flake before the transfer, calibrated for the specific objective lens. This allows for higher 2D material flake selectivity in terms of size and shape as per the requirement of the application. A camera software crosshair is used to align the position of flake, micro-stamper, and target using the respective stages. The soft PDMS helps in transferring the material over different structures as it wraps around the profile providing better contact of material with the target without damaging it. The thin (17 mil) PDMS sheets (Gel Pak) are cut down to small strips (1.5×3 cm²) and are mounted on a microscope glass slide based PDMS holder (herein termed as PDMS cartridge). This cartridge is held by clamp mount metal clips keeping the PDMS suspended in the air, mounted on an XYZ axis stage as seen in schematic FIG. 9(c). The clamp mount clips help to load and unload the PDMS cartridge with ease (quick release) and prevent disturbing the alignment of other parts when changing the 2D material source banks. This allows multiple PDMS strips with different 2D material source banks to be realized for building heterostructures without the need of loading and unloading new PDMS films with different materials.

The density of the flakes on Nitto tape is higher after exfoliation from a piece of crystal, forming clusters of un-isolated flakes. While transferring these flakes on a PDMS film, contacting the entire area of PDMS to the tape transfers clusters of 2D material flakes on the PDMS. The lower number of isolated flakes on PDMS leads to lower individual flake transfers from the 2D source bank cartridge. Therefore, it is important to transfer more isolated flakes on PDMS which are loosely adhered to the tape for ease of transfer and increasing the yield. A detailed description of the modified exfoliation of 2D material on PDMS film strips is discussed. The 2DMTS exfoliation graphical flow chart can be seen in FIGS. 9(d)-9(e) which show that the high density of flakes and overlapping clusters formed on the exfoliation tape can be avoided or reduced significantly by using this modified method. The chip or target substrate is cleaned by rinsing with acetone and isopropyl alcohol (IPA) followed by nitrogen drying and is placed on an XY-θ stage where the rotation helps to load and unload the substrate for transfer of 2D materials.

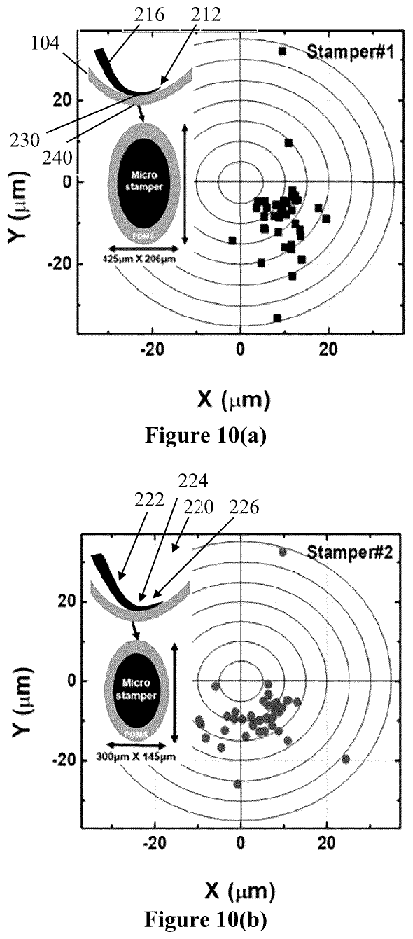

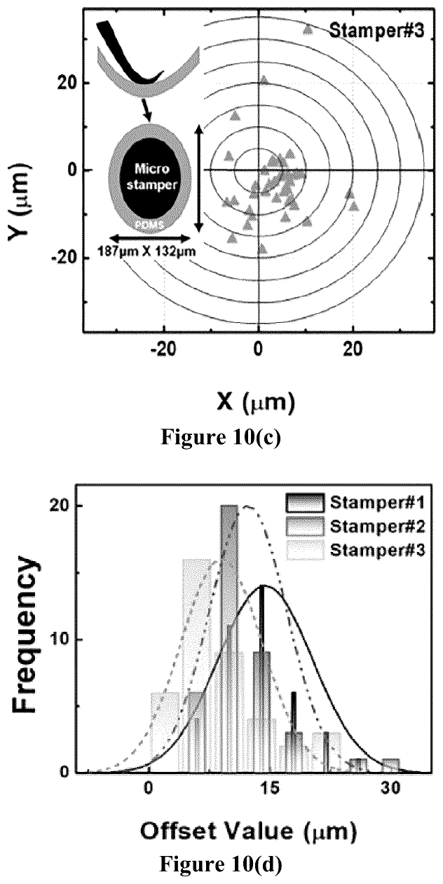

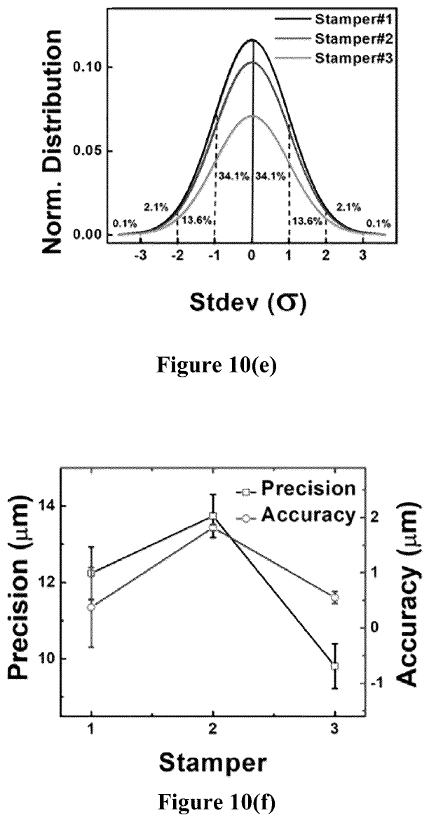

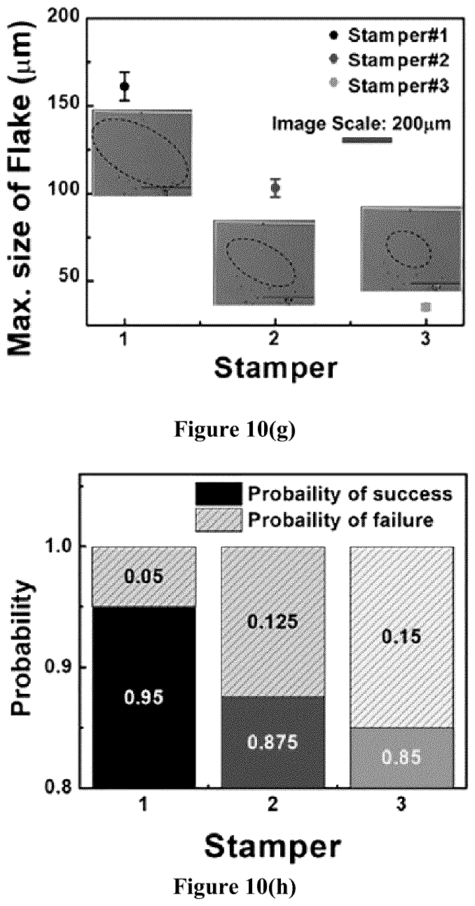

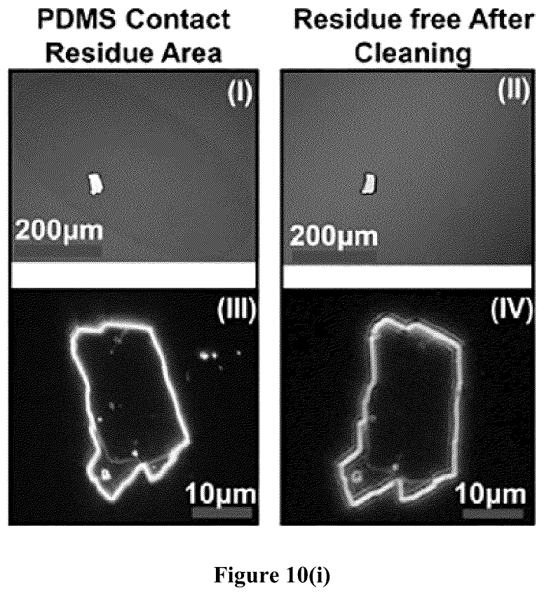

The flake transfer yield is about 95.0% (FIG. 10), which is higher than any other state-of-the-art transfer system so far reported, as the entire surface area of the flake contacts with the target forming better adhesion to the target area. The failure in transferring the flake can be caused mainly because of the rough surface of the flake due to improper exfoliation, thus reducing the vdW adhesion strength with the target. A flake larger than the micro-stamper tip size reduces the transfer probability and is prone to break the flakes causing defects. However, our different size micro-stamper range ensures that the stamper size matches the flake size. An apparatus can be provided that retains different sized micro-stampers and selects a micro-stamper size and/or shape that best matches a detected size and/or shape of the flake to be transferred. The contact area also defines the area of isolation required for each flake on PDMS to avoid multiple flakes being transferred, here solved by using a modified exfoliation process as seen in FIG. 9(d) to reduce the density of flakes on the PDMS film.

The 2DMTS setup transfer accuracy and precision are determined by experimental statistical analysis of the system. This analysis is based on independent experimental transfers of 80 flakes from different 2D materials (graphene, MoS₂, hBN, and WSe₂) for each stamper size by two different users. Thus, the dependency of a user experience, as observed in other transfer methods, is reduced by analyzing data generated by these two users who helped in the independent transfer of materials for producing data. The flakes were transferred on a patterned grid of gold boxes for determining the position of the transferred flake in isolation. The distances of flakes transferred are measured from the center of the crosshair to the center of the flake using the calibrated camera software. The long working distance objective lenses can be switched to different magnifications for; 10× coarse (target search), 20× fine (flake search), and 40× finest (flake transfer) alignment based on the target size. The exfoliated flake sizes range between 1 and ˜150 μm using Nitto tape.

In one embodiment, different elliptical tip-sized micro-stampers are provided, herein termed as stamper #1 (FIG. 10(a), 425×200 μm²), stamper #2 (FIG. 10(b), 300×145 μm²), and stamper #3 (FIG. 10(c), 185×130 μm²) for transferring exfoliated flakes. The imaging device, here the camera, captures the image of the target flake to be transferred. The system (such as the controller or a processing device), analyzes the captured image and determines the size of the target flake to be transferred. The controller then selects one of the stampers that is the closest in size to the target flake (e.g., the next size larger than the target flake), and that stamper is utilized for the transfer. In further embodiments, the stampers can have different shapes (e.g., diamond, oval, circle, rectangular, square), and different sizes for each shape; and the controller can select the size and shape that best fits the target flake (e.g., the shape and size that is slightly larger than the target flake and has minimal added space that might transfer unwanted material).

The flake position distribution after transfer for the three stamper sizes is also shown in FIGS. 10(a)-10(c), where the inset shows the respective micro-stamper schematic for the elliptical stamping shape. A systematic offset error is observed in all three distributions leading to poor accuracy and precision. This offset is produced due to additional optics added between the microscope objective and camera for better imaging and illumination, in addition to the refraction of the image due to the presence of PDMS in between the sample and microscope objective.

The size of the micro-stamper also contributes to the offset due to variation in stretching of PDMS during transfer. The histogram for the independent transfer attempts for each micro-stamper size shows the small systematic offset, indicated by the peak position involved in the transfer location for varying micro-stamper sizes, FIG. 10(d). Based on the iterative transfer test, the systematic offset error for each micro-stamper was calculated to be approximately ˜12.6, ˜8.4, and ˜5.8 μm for stamper #1, #2, and #3, respectively. Since the offset values for the given stamper size do not change, a constant shift is introduced to the software crosshair for making transfers. Therefore, the target location is perfectly aligned to the new offset introduced crosshair improving the accuracy and precision of the tool. The associated standard deviation distribution shows the dispersion of the transfer locations for each stamper normalized to the systematic offset error for each stamper, FIG. 10(e). The distribution clearly shows about 11.6%, 10.2%, and 7% transfer position variation from the offset crosshair for the respective stampers within ±16 of standard deviation.

The accuracy of the tool is defined by the mean value for the position distribution from the offset crosshair/target center. The spatial distribution density around the mean value for the position distribution is defined as the precision of the tool here. We can see from the distribution in FIGS. 10(a)-10(c) that the maximum distribution spread of the data is within the 10 μm range. FIG. 10(f) shows the accuracy of each micro-stamper demonstrating the highest accuracy of 0.7 μm with a precision of <10 μm (for stamper #3). Such accuracy and precision are vital in integrating the 2D material with highly dense photonic or electronic devices for on-chip and nano-sensing applications.

The smaller micro-stamper sizes provide higher accuracy and precision due to the small area of contact and lower offset deviation from the target. The maximum size of the flake that can be transferred and the effective area of contact of the PDMS with the three micro-stamper sizes considered in this article can be seen in FIG. 10(g). This helps the user to choose an appropriate stamper size for achieving optimized transfer accuracy for a desired flake size and target. The inset images represent the effective area of contact of PDMS to the target substrate when each flake is transferred and defines the area of isolation of flakes as well. The image contrast of the PDMS stamping area under the microscope is enhanced by the false color (purple) area for better representation.

For determining the yield of the transfer process produced by this system, we transfer flakes of different sizes at different random known locations on a SiO₂ substrate, FIG. 10(h). This experimentation is designed to test the reliability and repeatability of the system for multiple single flake transfers that can be achieved in a single attempt. The transfer of the 2D material flake to the target on the substrate, without cross-contamination of flakes around the target on the substrate and avoiding 2D material deformation cracking of the flake into pieces by any means, was termed as a success. A failure was noted if any of the condition was not satisfied. The probability distribution of the success and failure rate of the transfer system was calculated using this dataset as seen in FIG. 10(h). showing 95%, 87.5%, and 85% of success rates for each stamper, respectively. All the 40 independent transfers were made in sequence without making any changes to the PDMS film or setup alignment apart from searching the different flakes on PDMS and changing the target location. Therefore, the setup is proved to be highly repeatable, reliable, precise, and accurate for a wide range of applications that can be developed for science and technological advancements. Such a plethora of system properties has not been achieved under any other 2DMTS.

The flake and the PDMS contact area are cleaned using acetone followed by isopropyl alcohol (IPA) rinsed to remove any PDMS residues after transfer as shown in the figures. It is useful to consider samples where the material is transferred on a structured profile while rinsing and drying with nitrogen gas with as few vibrations as feasible. The vdW forces are prone to be not strong on the sides of the structures as the flakes may not conformally cover the structures owing to their thickness.

This prevents the transferred flakes from moving off the surface due to mechanical vibrations. The issue of weak conformality of the flake coverage can be solved by keeping the sample in a vacuum chamber for 20-30 min. This strengthens the adhesion of the flake with the structure profile. On the sample, darkfield microscopy, optical filter-based microscopy, or secondary electron microscopy (SEM) can be used to check the results of the cleaning process depending on the resolution of inspection. As seen in FIG. 10(i), a molybdenum disulfide (MoS₂) flake was transferred on SiO₂ substrate, and the contact area can be observed using a microscope, but the contrast is very poor for such small particles. Therefore, the area is enhanced by contrast correction which represents the area of contact in FIG. 10(i-I). The difference, in contrast, represents the contacted area of PDMS on the substrate and top of the flake. The residues are completely removed after the post-transfer simple cleaning process as seen in FIG. 10(i-II). The clean surface of the flake is verified using darkfield microscope images before FIG. 10(i-III) and after the cleaning process FIG. 10(i-IV). This shows that the quality of the transferred flake is highly preserved along with no cross-contamination of flakes on the entire substrate.

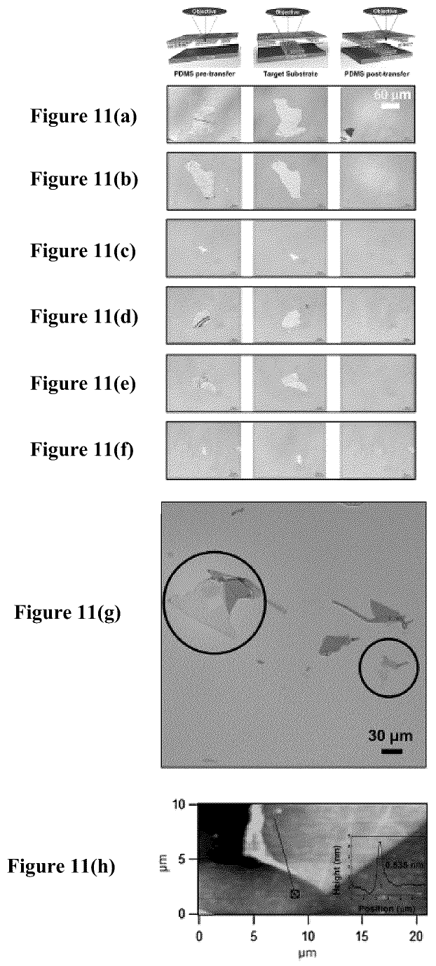

Furthermore, understanding the non-cross contamination process while transferring multiple flakes in different locations on the substrate is necessary for repeatability and reliability demonstration. Also, there are possibilities of producing wrinkles or bubbles under the flake, cracking of large-sized flakes, and accidental transfer of a nearby flake after the transfer process. In FIGS. 11(a)-11(f), different sizes and shapes of graphene material flakes are transferred on a SiO2 substrate showing the optical images of the flake on PDMS, flake transferred on the substrate, and of PDMS at the same location after transfer captured while using the 2D printer. The isolation of a nearby flake from the target flake while transfer can be observed in FIGS. 11(a) and 11(f) where the flake on the side does not touch the substrate during the transfer process and can be seen left on the PDMS after transfer of the target flake. However, small flakes within the range of a few micrometers cannot be avoided from getting transferred as it is difficult to isolate such small distances from cross-contamination as verified statistically in FIG. 10(g) to the stamper size. Furthermore, these images show that the wrinkling or folding of material caused due to the viscoelastic nature of PDMS does not reflect after transfer on the substrate due to slight stretching on PDMS while stamping. This also indicates that the 2D material flakes are not strongly adhered to the PDMS due to the modified flake transfer technique discussed in FIG. 9(d) making it easy to transfer it on structures as well. Finally, if small wrinkles are produced after the transfer, the sample can be kept in the high vacuum chamber to remove it.

### 2DMTS Preparation and Device Fabrication Process.

Another embodiment of the micro-stampers 202 is shown in FIGS. 10(a)-(c). Here, only the intermediate portion 216 and a distal end portion 220 of the body 210 are shown (see FIG. 3(a)). The distal end portion 220 has a proximal section 222, middle section 224, distal section 226, and a distal end face 212. The proximal section 222 of the distal end portion 220 leads into the intermediate portion 216. The distal end portion 220 is tapered and slowly narrows as it progresses from the proximal section 222 to the distal end face 212. In some embodiments only a portion of the distal end portion 220 is tapered; for example, the middle section 224 need not be tapered (to have a reducing size/diameter), but instead can be substantially straight or linear (with a uniform size such as diameter or width and/or thickness) so that a contact portion 230 has a uniform size and/or shape. Or, only the contact portion 230 need not be tapered but instead can be substantially straight or linear with a uniform size and shape.

As further illustrated in the embodiment of FIGS. 10(a)-(c), the intermediate portion 216 is linear or straight, and the distal end portion 220 is curved to form a J-shape or hook-like shape. The curvature is configured to form a stamper contact surface 230 along one side of the distal end portion 220. The stamper contact surface 230 is on the outer-facing surface that faces the transfer material 104. The stamper contact surface 230 contacts the transfer material 104 to press a transfer material contact surface 240 of the transfer material into contact with the target flake to be transferred. The transfer material 104 forms a radius of curvature that gets smaller as the transfer material 104 continues to stretch. The radius of curvature of the distal end portion 220 is sufficiently large to avoid puncturing the transfer material 104, but sufficiently small to form a small enough stamper contact surface 230 for transferring small flakes.

The entire distal end portion 220 can have the same radius of curvature, from the proximal section 222 all the way to the distal end face 212. Or, the radius of curvature can vary along the distal end portion 220. For example, the proximal section 222 of the distal end portion 220 can be slightly angled or curved by a first radius of curvature, the middle section 226 can have a second radius of curvature, and the distal section 224 can have a third radius of curvature. And, the first radius of curvature can be substantially larger (i.e., slightly curved) than the second and third radii of curvature, and the second radius of curvature can be much smaller (i.e., more curved) than the third radius of curvature. However, additional variations of curvature can be provided along the distal end portion 220. For example, the distal end face 212 can be further curved inward and away from the transfer material 104.

As further illustrated, the distal end portion 220 has a round cross-section shape, such as a circle or oval, to avoid sharp edges that might otherwise pierce the transfer material 104. For a circular cross-section, the stamper contact surface 230 is along one curved side of the distal end portion 220, and in one embodiment is at the middle section 224 of the distal end portion 220. Accordingly, the distal end face 212 is positioned at a distance from the stamper contact surface 230, and is the distal end face 212 is recessed with respect to the leading portion of the stamper contact surface 230. The stamper contact surface 230 is more curved and better supports the transfer material 104 as the transfer material 104 flexes, to avoid piercing the transfer material 104. In other embodiments, the cross-section can have other shapes that distribute the contact surface and force on the transfer material 104, while maintaining a small contact surface sufficient to transfer a single flake.

In one embodiment, the micro-stamper 202 is fabricated by modifying tungsten electrical probe needles. The needle is placed on the holder at 45°, then lowered perpendicularly, and forced on the metal plate to bend the needle's distal end portion 220. The amount of force given to the needle to bend the distal end portion 220 determines the size of the distal end portion 220 bent. The curved distal end portion 220 provides a smooth tip characteristic to the micro-stamper, preventing piercing in the PDMS sheet 104. The size of the stamping area is calculated by measuring the PDMS contact area after transferring. The intermediate portion 216 of the stamper can be held at the desired angle (here, 45°) with respect to the transfer material 104, to press and flex the transfer material 104 into contact with the substrate. It is noted that other suitable angles can be provided from about 0°-180°, or from about 30°-60°, though the curved outer stamper contact surface 230 is substantially parallel to the inner surface of the transfer material 104.

Reusable PDMS Holder Preparation

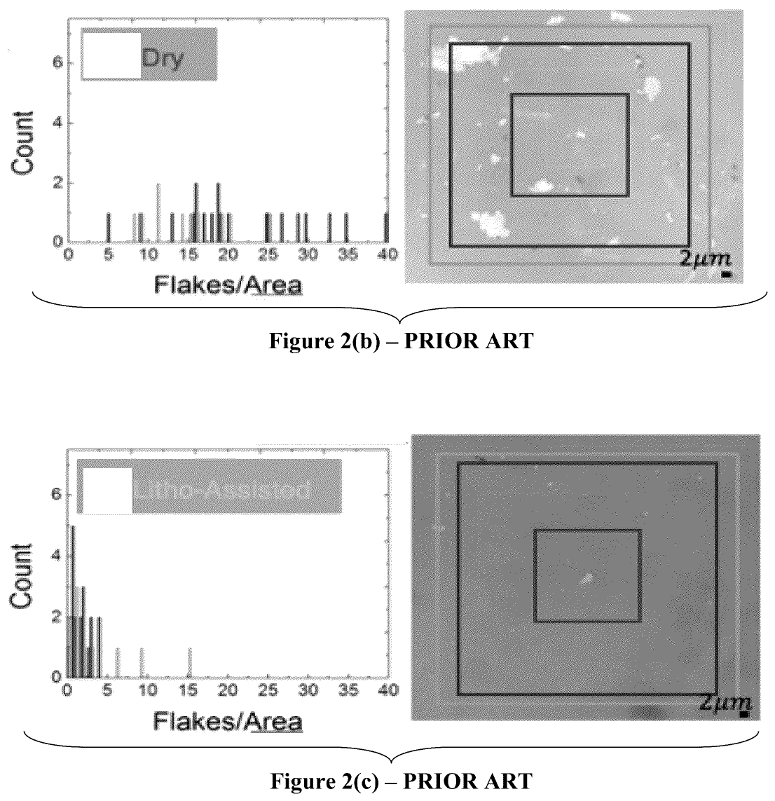

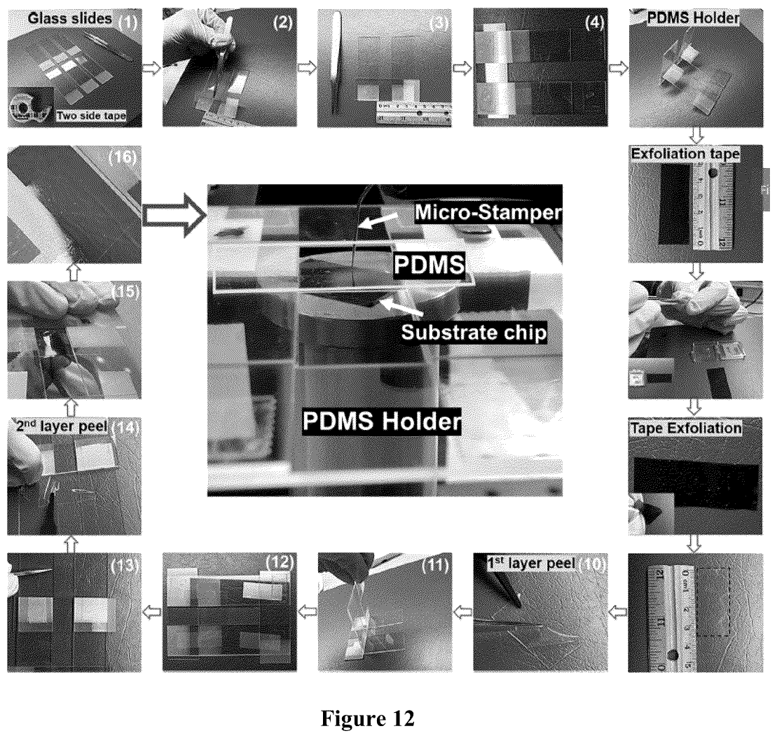

The PDMS holder serves the purpose of holding multiple PDMS strips (here three) with a choice of having different/same material on each of the PDMS strips. The PDMS holder requires six thin glass slides (˜1.2 mm), Gel-Pak thin PDMS film (17 mils) strip/s, double-sided and single-sided adhesive tapes. The pictorial representation of preparing the PDMS holder is shown in FIGS. 11-1 to 11-5. FIG. 12 is a step-by-step pictorial flow chart for PDMS holder preparation and modified exfoliation technique. The holder can be reused once prepared by replacing the PDMS film clamped in between the glass slide frame. The preparation of the holder requires thin glass slides (˜1.2 mm), gel-pak thin PDMS film (17 mil), double-sided and single-sided adhesive tapes, pair of tweezers, weak adhesion exfoliation tape, ruler, and 2D material crystal. The figure in the center shows the placement of the holder on the stage for finding and positioning the 2D material flakes.

Exfoliation Process

The exfoliation of 2D materials is a widely accepted technique using a weakly adhesive Nitto tape (e.g., K. S. Novoselov et al., “Electric field effect in atomically thin carbon films,” Science 306(5696), 666-669 (2004)). To transfer the material onto the PDMS film, a pair of tweezers, weak adhesion Nitto exfoliation tape, a ruler, PDMS strips, and the desired 2D material crystals are needed. A small piece of crystal from the bulk 2D material is placed on one end of a Nitto tape strip with a width equivalent to that of a PDMS strip. The other end is closed on the crystal and peeled back and forth until a lot of flakes spread on the tape.

The tape is usually then contacted with the substrate/target to transfer the flakes that have adhered to it. However, residues from the tape glue and other particles stuck to the tape are also added, resulting in a decreased yield of good-quality flakes in the traditional transfer technique. In addition, this spreads a lot of clusters of overlapping flakes all over the substrate, resulting in cross-contamination. The tape is gently pressed against the suspended PDMS cartridge a few times (FIG. 12-15). This permits the loosely bonded flakes on tape to adhere to the PDMS naturally by capillary force, reducing flakes clumping and allowing for more isolated flakes to be transferred. The strongly bonded flakes with glue residues are not transferred and reduce glue contamination on PDMS and flakes to be negligible. Furthermore, the entire process is performed at room temperature. A complete pictorial procedure can be seen in FIG. 12.

Transfer Process

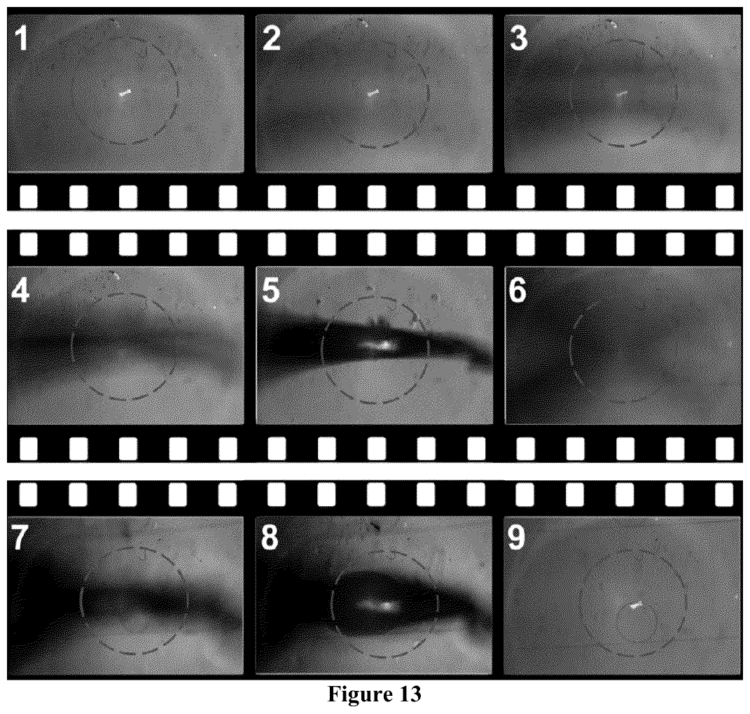

The transfer process is simple and highly effective using the 2DMTS. FIG. 13 shows real-time video frames acquired during the transfer of WSe₂ flakes onto a silicon micro ring resonator (MRR) structure. The numbers on each frame denote the order in which the frames were captured during the transfer. Frames 1-4 show the micro stamper approaching the PDMS. The growing shadow on top of PDMS helps determining the closeness of the microstamper toward the PDMS film. Frame 5 shows the micro stamper tip contacting the PDMS which indicatively can be observed by the sharpness of the shadow projected on PDMS. The focus of the microscope is shifted to the target at this point, where the stamper shadow is blurred (frame 6). As the stamper approaches the target for transfer, the shadow tends to be sharper (frame 7). The PDMS contact to the target can be clearly seen in frame 8 where the motion of the stamper is stopped. The frame 9 shows the stamper reverting to its original location with the flake being transferred on the MRR.

The entire system is independent or requires a minimal need for user experience and training. This makes this system more user-friendly as compared to other systems and avoids long training periods for a new user. The entire transfer process can be implemented in three simple steps: (i) Finding the flakes, (ii) positioning the flake and target area, and (iii) transferring the material. The desired size and shape of the flake can be selected on the PDMS by moving in the XY direction and using the measurement feature in the camera software. The microscope focal adjustment can be used to transfer the focus of vision to the micro-stamper, PDMS, and through the PDMS on target, once the PDMS holder is loaded on the stage.

Using the micro-manipulating stages, a software crosshair assists in positioning the 2D material flake, target, and needle to a precise overlapping position. Following this alignment, the target and PDMS can be adjusted in the XY direction as needed to locate the flake and/or adjust the target's position. Once aligned to the center of the crosshair (homing position), the micro-stamper can be moved in the Z direction to make transfers. When PDMS touches the sample, the live video exhibits distinct indicators, allowing the operator to avoid over pressing the micro-stamper on the material while transferring. Once the PDMS has contacted the substrate, the operator can carefully bring the micro-stamper back to the homing position and repeat the operation for other flakes on the PDMS and target locations on the substrate.

The micro stamper exerts stress of ˜450 kPa on the PDMS film while transferring simulated by ANSYS static structural simulation. The pressure exerted on the flake and substrate during transfer is experimentally measured by placing a pressure sensor under the target substrate resulting in ˜13 kPa which is within the elastic limit of 2D material (GPa), and PDMS material (MPa). The simulation results for the stress and strain analysis of the 2DMTS on PDMS and substrate are discussed in detail in the supplementary material.

Nano-Fabrication Process

The devices discussed herein follow similar process steps unless otherwise specified further in the discussion. The study is performed on commercial Si photonic chips (Applied Nanotools, Inc.) tape-out. The flakes in all the applications discussed were transferred using the proposed system. The samples were rinsed clean using acetone followed by isopropyl alcohol for a few minutes, both before and after transfer. The electrical contacts were patterned using an e-beam lithography process assisted by prepatterned alignment markers for positioning the flakes while making contacts. The Au/Ti (45/5 nm) metal deposition was performed by e-beam evaporation technique followed by a liftoff process using acetone at room temperature.

Electrical and Optical Measurement Setup

The experimental setup for measuring the heterogeneously integrated TMDC-Si devices comprises a tunable laser source (Agilent 8164B) and a broadband source (AEDFA-PA-30-B-FA) from where light is coupled into the grating coupler optimized for the propagation in the waveguide for 1550 nm wavelength. The light output from the Si-MRR is coupled to the output fiber via a grating coupler and detected by a detector or an optical spectral analyzer (OSA202). A source meter (Keithley 2600B) was used for electrical measurements. A tunable (NKT SUPERCONTINUUM Compact) source and fixed wavelength laser diode module (CPS980 Thorlabs, Inc.) at 980 nm wavelength was used as sources for measuring the heterojunction based PN junction photodetector devices.

Applications

Electrical Characterization of 2D Materials Post-2DMTS Transfer

FIGS. 13(a), (b) are based on an extensive study performed on electrical properties of 2D materials, indicating the effect of impurities, trapped contaminants, and defects caused while transferring the material or post-process effects. It is important to study the electrical properties of the material after contact formation for optimized performance. However, achieving consistent results in the electrical properties of such devices is challenging for other transfer methods discussed earlier. To demonstrate consistency in the quality of flakes transferred using the proposed system, we performed transmission line measurement on these flakes for sheet resistance measurement. The results were normalized by the area of the flake to remove the effect of the shape and size of flakes from the resistance measurement.

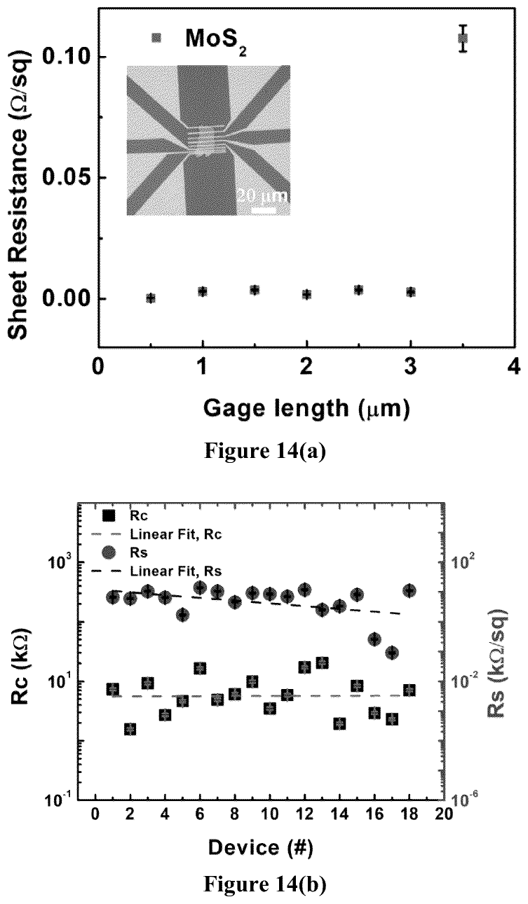

Flakes with uniform thickness surfaces were considered for measurement confirmed by Raman spectroscopy before making the contact pads. As seen in the microscope image in FIG. 14(a) inset, MoS₂ flakes were transferred on the SiO2 substrate, and contacts were formed for different gauge lengths from 0.5 to 3.5 μm with a step size of 0.5 μm. This type of electrical characterization helps in designing the next generation devices for improved optoelectronic device performances. FIG. 14(a) shows the variation in sheet resistance with varying gauge lengths on the same flake representing the sheet resistance.

Several such devices were fabricated at once by transferring multiple flakes on the SiO₂ substrate for testing repeatability in achieving similar electrical properties. Repeatable electrical characterization was achieved by building 18 devices and observing their respective contact resistance (RC˜<50 kΩ) and sheet resistance (RS˜<10 kΩ/sq) of MoS₂ flakes as seen in FIG. 14(b). The electrical characterization of 2D materials is an important aspect to be studied for building electrooptic devices, magnetostatic devices, and stretchable electronic devices.

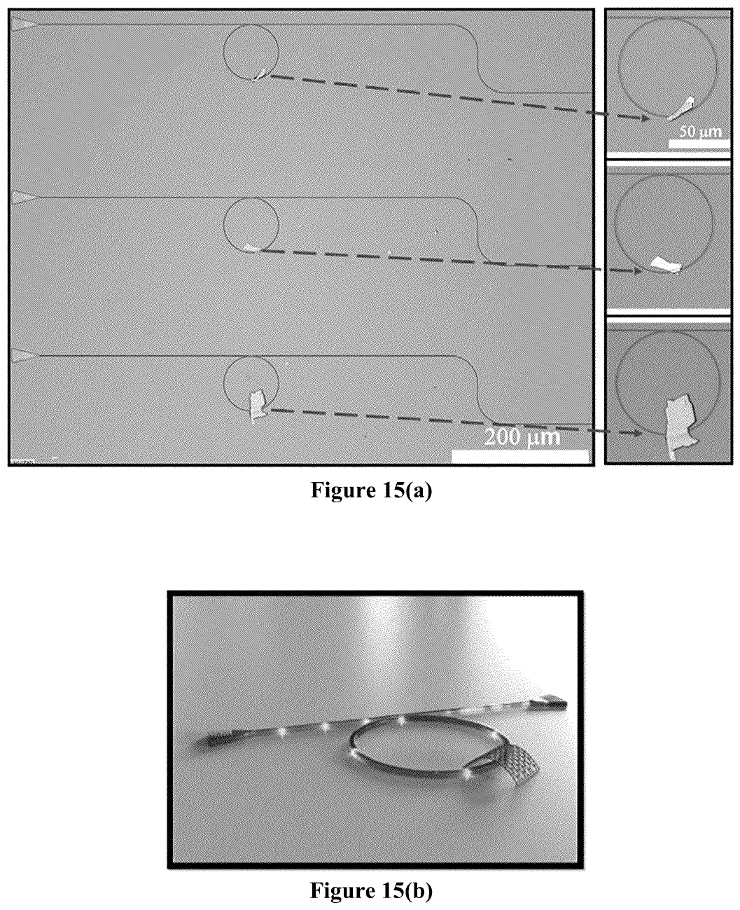

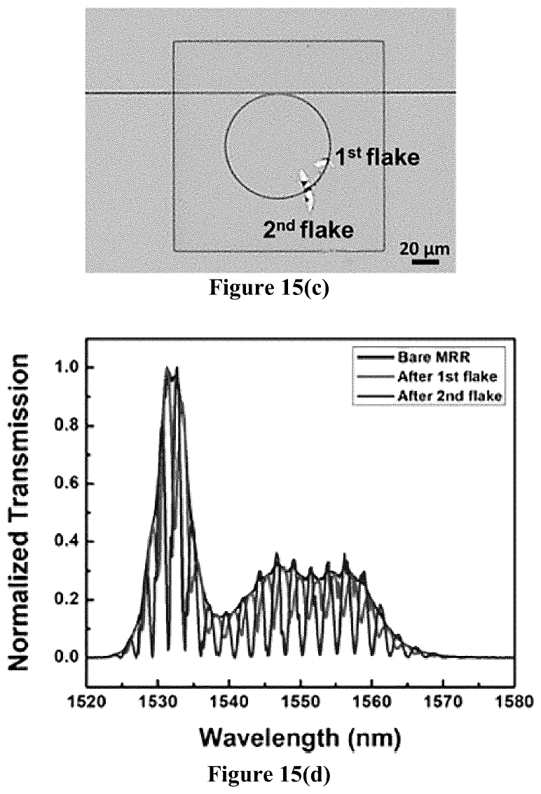

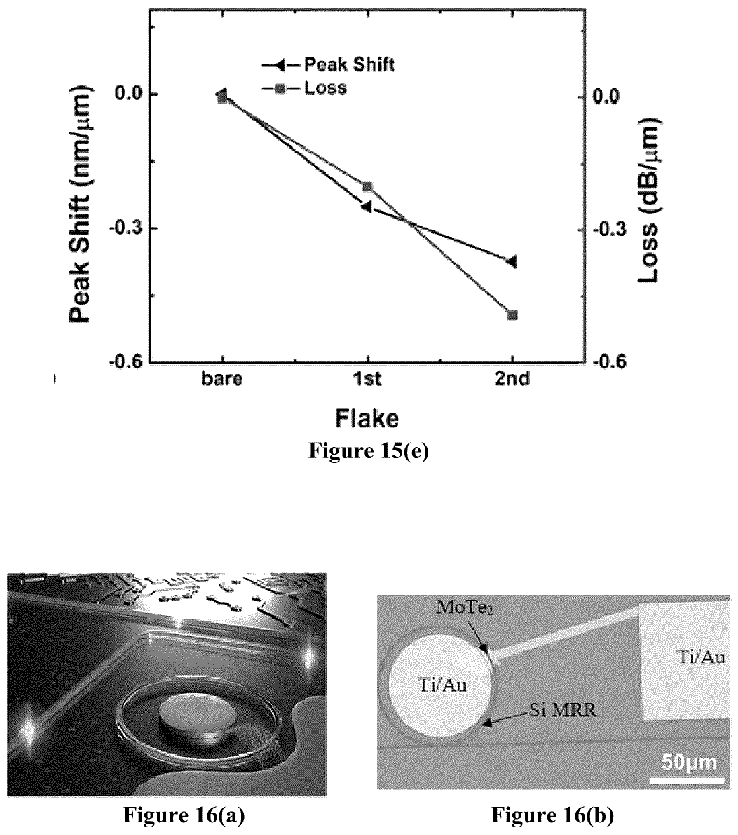

Precise Transfer on an Array of Devices On-Chip (FIGS. 15(a)-(f))

It is important to increase the yield of devices that can be fabricated for extensive research studies or commercial mass fabrication. A simple experiment is demonstrated here which proves the precise and accurate transfer capability of the system producing multiple devices on a chip in less than one minute spent on each device to transfer and a few minutes in searching the desired flakes. The flake search time of a few minutes can be minimized by pre-scanning the PDMS film and registering the flake positions using the top-mounted camera and a computer program by image processing. A commercial Si-photonic chip with arrays of micro-ring resonator (MRR) devices separated by 200 μm distance was used in this experimentation. Each MRR was positioned under the system to transfer one flake in a sequence without changing any settings of the setup. The 2D material flakes, here MoS2, were chosen at random and were targeted to be transferred at the same position on MRR for each device. Such transfers were made on 15 devices in a column on-chip of which three devices are shown in FIG. 15(a) with a close view for the transferred flake. Such robustness of the setup can be used to make devices for producing active and passive tunable devices with higher yield and repeatable results as discussed further.

Post-Passive Tunning of Silicon

The designed performance of silicon photonic circuits may vary due to fabrication uncertainties or incorporation of multiple post fabrication process steps for fabricating active control of devices on chip. Also, tuning photonic circuits with precise control over the amount of changing properties can be used for applications in neuromorphic computing. A novel study was extensively discussed in past showing tunning of silicon microring resonator (MRR) coupling efficiency from under-coupled to the over-couple regime after the MRR was fabricated using MoS2 using such stamping technique. Such studies can be crucial in understanding the effect of different 2D materials on optical properties after integration further helping to understand the optical properties of 2D materials like refractive index, optical absorption, phase change, and emission. Using the proposed 2DMTS, such devices and study can be accelerated for studying any 2D material characterization study.

We here demonstrate a similar device as discussed in R. Maiti et al., “Loss and coupling tuning via heterogeneous integration of MoS2 layers in silicon photonics,” Opt. Mater. Express 9(2), 751-759 (2019), showing enhanced coupling efficiency of Si-MRR from under the coupled regime to critical coupling regime as seen in FIG. 15(b). The MRR was transferred with two different small flakes as discussed in FIG. 15 demonstrating precision in transferring flakes on devices extremely close to each other (here ˜25 lm), as seen in FIG. 15(c). The MRR spectral resonance enhancement was observed after transferring each of the two flakes to understand the change in coupling conditions by tuning the effective refractive index given by (Δn)_{(eff,ring)}=((2πR−L)*n_{(eff,bare)}+L*n_{eff})/2πR and seen in FIG. 15(d). Optical loss due to scattering from material edges and change in the imaginary part of the effective refractive index of the MRR was in total observed to be about 0.00251 dB/μm, represented in FIG. 15(e).

Strain Engineered MoTe₂ Integrated Photodetector on the Silicon Microring Resonator (MRR)

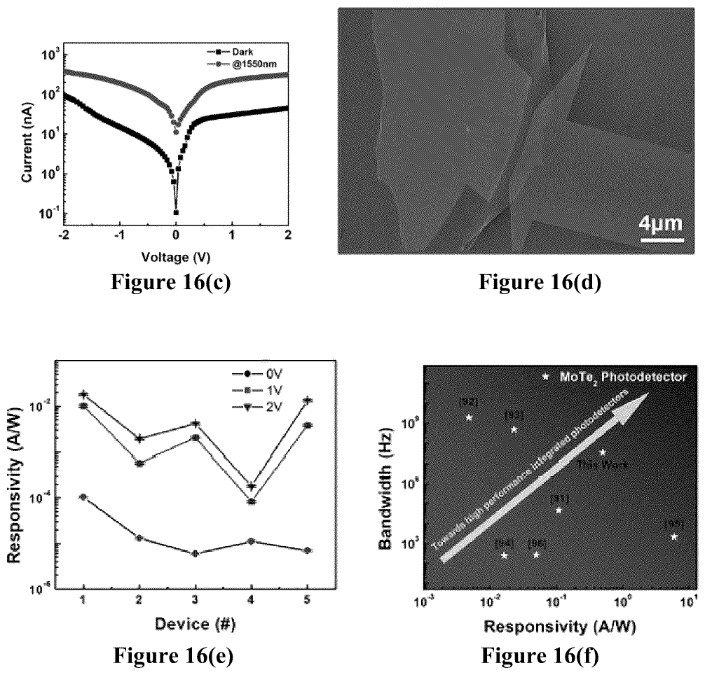

We demonstrate a heterogeneous integration of the 2D material using the proposed transfer system on a silicon photonic circuit Onchip using a few-layer MoTe₂ flake. Owing to the bandgap of MoTe₂, the optical absorption of the material is not suitable for 1550 nm light detection. Using the proposed 2DMTS, the material can be strained on Si waveguides which enables bandgap tuning of MoTe₂ and therefore, allows the material to absorb at lowered bandgap due to induced strain. A single few-layer MoTe₂ flake was transferred on a silicon MRR based photodetector with 0.5 A/W responsivity operating at 1550 nm wavelength. A similar device has been designed and fabricated here for demonstrating the capability of the transfer system for realizing and studying such devices. The flake was transferred on a silicon MRR precisely using a micro-stamper and was patterned using the lithography process for contacts as seen in FIG. 16(a). The microscope image as seen in FIG. 16(b) shows the device structure with electrical contacts. The current-voltage (I-V) characteristics of the device can be observed in FIG. 16(c). A high responsivity of 0.02 A/W (R=Iₚₕₒₜₒₙ-I_{dark}/Pᵢₙ) was achieved for 2V electrical bias at 1550 nm telecommunication wavelength. The dark current is observed around 50 nA. A close view of the SEM image of the flake placed on the MRR can be seen in FIG. 16(d).

Multiple photodetector devices were studied here for different thicknesses, shapes, and sizes of the flakes, on the same chip with each MRR away from each other by 200 μm showing the capability of array transfer represented in FIG. 9(b) to develop such devices with high repeatability. The responsivity of five such photodetectors at no bias (0V), 1, and 2V can be seen in FIG. 16(e) integrated on Si-MRR with light coupled at 1550 nm. The variation in performance for each device is due to variation in the coverage area of flake due to different sizes and variations in thickness. A detailed study of the effect of strain used to tune the absorption bandgap of MoTe₂ for such devices is known toward strain optronics applications. These types of devices are promising for future on-chip detection and modulation of the signal without a complex fabrication process and high cost of production.

Strain Effect on WSe₂ Bandgap Stretched on Nanostructures

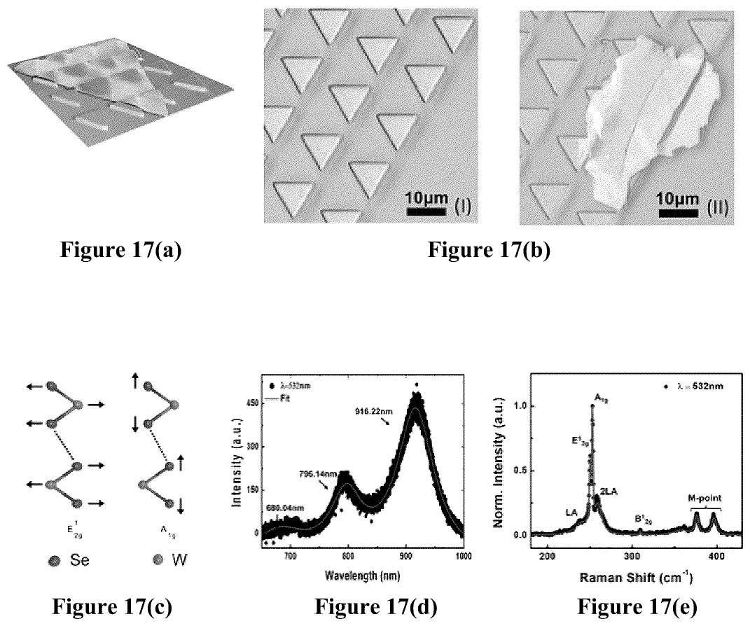

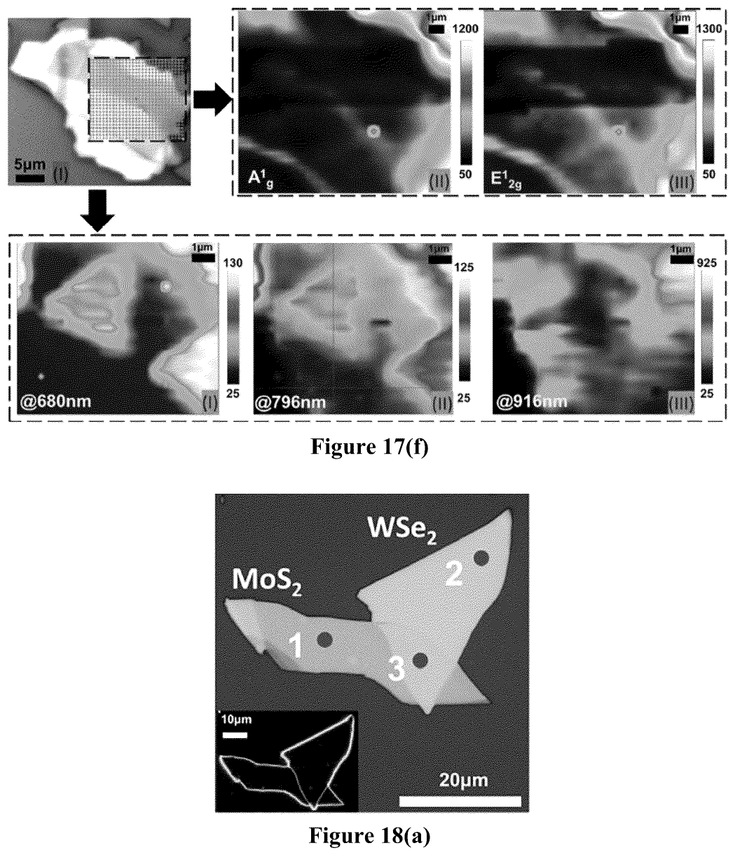

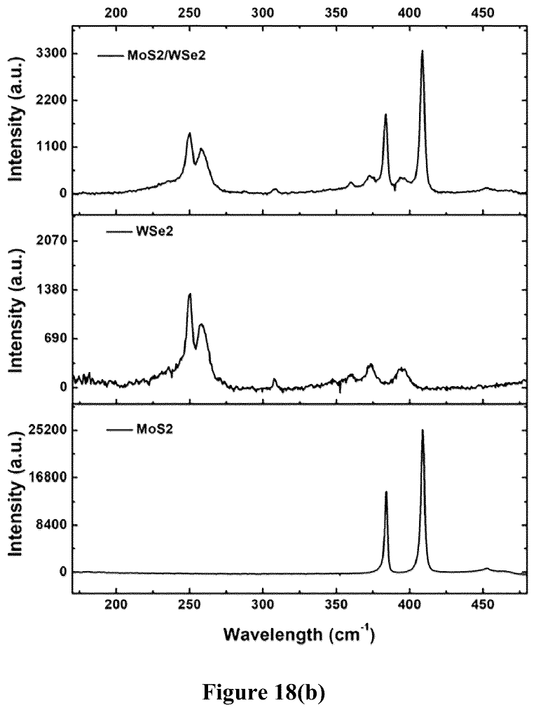

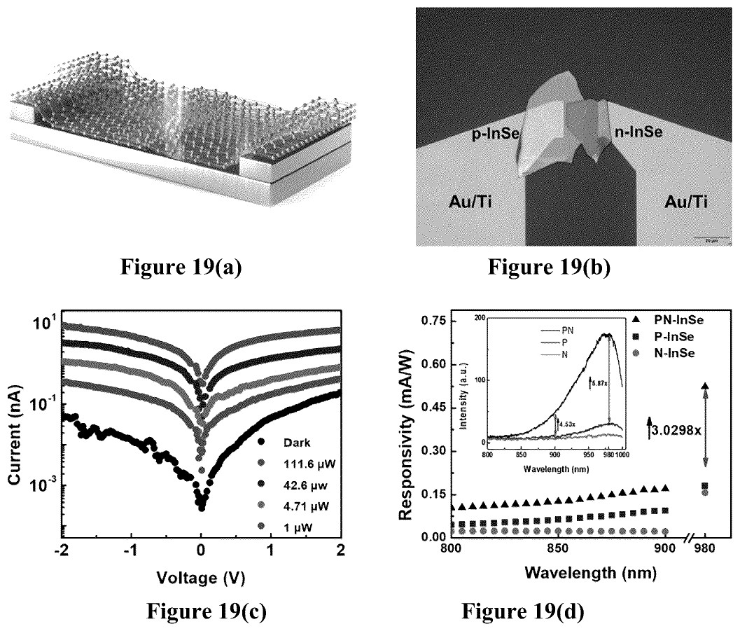

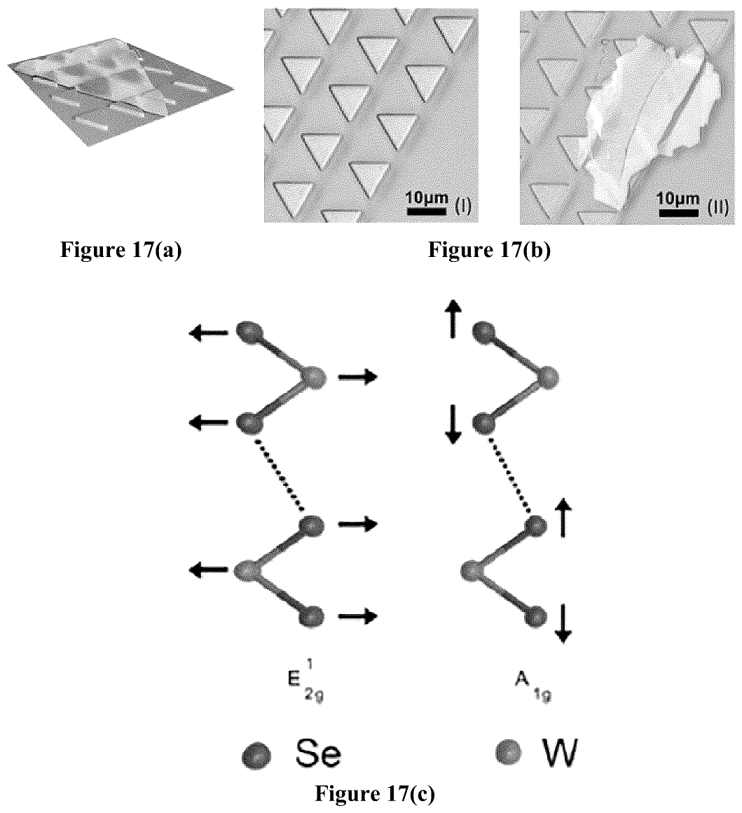

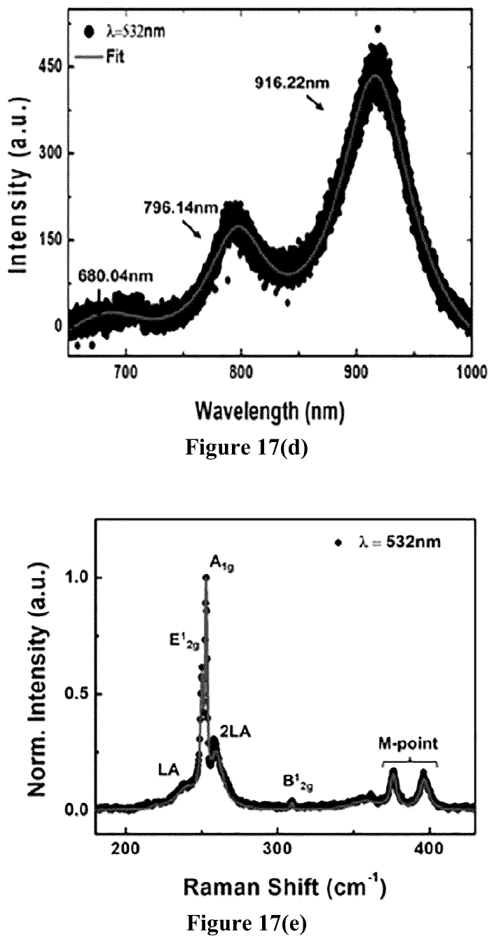

The atomically stacked 2D materials with each atomically thin layer adhered to each other under vDW forces show unique and strong tunning capabilities of modulating its properties by using mechanical forces. The properties of WSe₂ like photoluminescence (PL) enhancement, bandgap tuning, quantum emission, and optical absorption can be modulated by generating strain in the material. Here we demonstrate the strain effect on WSe₂ multilayer using triangular geometric pillars. The pillars are etched from a SiN substrate of height 220 nm. The structures are equally spaced to allow part of the flake to slack in between pillars and also stay suspended in a few parts as seen in FIG. 17(a). FIGS. 17(b-I) and 16(b-II) show the microscope image of the nanopillars after the etching process and after a large WSe₂ flake transfer on the same area using the proposed transfer system, respectively. In this configuration, it was possible to suspend the flake like a membrane on multiple nanopillars producing a high strain gradient along the pillar area. The corners of the triangular area help in strongly straining the membrane due to the virtue of the geometric shape. To understand the effect of induced strain, here, we performed photoluminescence and Raman spectroscopy spatial mapping. The Raman active modes of WSe₂ are represented in FIG. 17(c). The PL spectra were analyzed by fitting the data to find the significant peak positions as seen in FIG. 17(d). The peak positions are highlighted in the figure at which the PL map analysis is performed for strain effects.

The crystal lattice vibrations of bulk WSe₂ include Raman active modes of A_{1g}, E_{1g}, and E_{2g} (FIG. 17(e)). In Raman tensor analysis, the E-modes and A-modes are studied using circularly polarized helicity configuration. In the LR configuration (incident with left circular polarization and collect right circular polarization signal), we can get 247.4 cm⁻¹ peaks consistently which denotes the E¹_{2g} mode peak, while in the LL configuration (incident with left circular polarization and collect left circular polarization signal), we have the 249.5 cm⁻¹ peak which corresponds with A_{1g} mode (FIG. 17(e)). As seen in FIG. 17(f-I), an area was selected on top of a few pillars with a small grid representing the mapping density used during the measurements. The effect of strain caused physical atomic arrangement variation in the crystal leading to change in vibrational modes of the material. FIG. 17(f) shows the Raman mapping profile of the WSe₂ membrane strained on a pillar showing the change of almost three times than the unstrained region in the intensity of A_{1g} mode (II) and E¹_{2g} mode (III). The intensity variation here also shows the curved surface profile of the membrane on the pillars and the change in the peak intensity due to the strain introduced in the material. Further to test the optical response of the material under strained conditions, photoluminescence spectroscopy was performed to observe intensity enhancement at the significant peaks observed in FIG. 17(d).

For WSe₂, the PL spectra mapping was performed at 680, 796, and 916 nm to understand the effect of strain on each of them. Such studies can help in understanding the material properties to design and fabricate devices for exotic applications in various fields. The intensity map of PL for the strained region on one of the pillars at each of the significant peaks can be seen in FIG. 17(g). An enhancement of about 4.5× and 3× was observed at 680 (I) and 796 nm (II) peak positions, respectively. However, a reduction in the intensity of about 2.7× is observed at 916 nm (III). The selective tuning of the photoluminescence response of WSe₂ can be used for designing optical filters or spectral selective absorbers integrated on photonic circuits.

Building 2D Material Heterostructures

When we assemble numerous 2D crystals into a vertical stack, a multitude of possibilities emerge for exploring various properties exhibited by these materials. Such heterostructures, held together by vdW forces, allow significantly more combinations than any other standard material stacking growth process. The intricacy of the heterostructures that could be constructed with atomic accuracy is increasing as the family of 2D crystals grows. Such 2D heterostructures can be used to build devices for electronic or electro-optic applications, superlattices, and quantum applications. Here, we demonstrate a small example of building a MoS₂/WSe₂ heterojunction using the proposed 2D transfer system. A simple demonstration of combining individual unique properties of MoS₂ and WSe₂ by forming a junction from the heterostructure. Both the MoS₂ and WSe₂ are transferred on a SiO₂ substrate to form the heterojunction as shown in FIG. 18(a). The inset in FIG. 18(a) shows the dark-field microscope image of the heterostructure confirming the clean surface on the flakes and substrate.

By experimental analysis of the unique material signature exhibited by Raman spectroscopy, we observe the combined effect of both the materials in a heterostructure. As seen in FIG. 18(b), the Raman spectra for individual flakes of MoS₂ and WSe₂ can be observed with their active mode peaks. The MoS₂/WSe₂ heterojunction Raman spectra exhibit the Raman active modes of both the materials combined. The location for detecting the Raman signal is marked on the optical image in FIG. 18(a). The data were corrected with background signal and baseline correction for removing the unwanted noise in the signal. This example shows the capability of the setup to realize heterostructure formation for different applications. The angle between each layered stack can be controlled in the setup for twistronics and superlattices applications as well but not discussed here.

InSe Based PN-Junction Heterostructure Photodetector

Since past decades, 2D materials have been studied as promising photodetector materials, by changing the layer numbers or forming vdW heterostructures, owing to their high responsivity, fast response, broadband detection, low dark-current, and photo-detectivity. The operation of these high-performance devices demands high bias voltage leading to large power consumption. This limits technological applications in extreme environments, biomedical imaging, portable devices, etc. 2D indium selenide (InSe) has recently been investigated showing higher ultrasensitive photodetection characteristics than other 2D semiconducting materials such as MoS₂ and WSe₂. Junction-based, e.g., p- and n-doped materials enabled realization in heterostructure devices by the formation of an atomically sharp p-n junction.

Using 2DMTS, here we demonstrate a vDW heterostructure based photodetector for near-infrared (NIR) spectrum absorption capable of efficient photo-detection operation at zero-bias enabled by a built-in voltage from the 2D material PN junction. The important aspect of vDW 2D heterostructure is achieving a clean interface between the layers. In general, the quality of realizable heterojunctions is affected by chemical or mechanical degradation due to the presence of residues from adhesive from Nitto tape, polymer adhesives, or wet chemicals depending on the transfer method. By using a dry transfer medium and the mechanical stamping mechanism of 2DMTS this issue is eradicated. We heterogeneously integrated p-(Zn) and n-(Sn) doped InSe material using 2DMTS on pre-fabricated electrical contacts (Au/Ti) (FIG. 19(a)).

The sample was kept in the vacuum chamber for 30 min for better layer-layer and layer-metal adhesion. The optical microscope image seen in FIG. 19(b) shows the actual device configuration and structure of the electrical contacts. The center region forms the p-n junction formed by the heterostructure. The device's current-voltage characteristics were tested to observe dark current and photocurrent generation for 980 nm wavelength illumination. The change in photocurrent for different optical power was also tested at 980 nm showing a gradual increase in photocurrent as seen in FIG. 19(c). the spectral response of the pn junction photodetector was performed for a range of wavelengths from 800 to 900 nm using a tunable broadband source and also at 980 nm using a laser module (vertical-cavity surface-emitting laser (VCSEL)).

A similar device with only n-doped and p-doped InSe channels was fabricated for comparison with the pn junction configuration of the device for the spectral response as seen in FIG. 19(d). An enhancement of about 3× was observed in responsivity of about 0.524 mA/W for the pn-junction InSe photodetector as compared to only the p- or n-doped InSe photodetector. The responsivity enhancement is due to the increase in the photoexcited electron-hole pairs between the p- and n-layer producing indirect excitons. These excitons have a higher carrier lifetime leading to enhanced performance of the device in photodetection.

The inset shows the PL emission for the p-, n-, and pn junction area of the device. An intensity enhancement of 5.9× and 4.5× is observed from the pn-junction at 980 and 900 nm wavelengths, respectively. This behavior aligns closely with the experimentally tested spectral response of the device. This signifies the generation of new strong absorption peaks in the heterostructurally built material lattice as compared to its natural material form. Such tunability of band absorption can be used for applications in the NIR spectra like LiDAR, gas sensing, photodetectors, optical modulators, and biosensing devices built using the proposed 2DMTS.

### CONCLUSION

In summary, the family of 2D crystals is continuously growing, both in terms of variety and number of materials as the scientific community progresses rapidly in enhancing the properties in these materials. In this work, we have successfully designed, developed, and demonstrated a novel robust transfer system for 2D materials for Onchip integration for building heterogeneously integrated devices and constructing heterostructures for applications like optoelectronic devices. Using a state-of-the-art micro-stamper and thin bendable film we were able to significantly improve the transfer of 2D materials reliably, with high repeatability, and without incurring any cross-contamination. The latter is a parasitic effect that is often caused by other transfer methods and eliminating this enables chip-industry like repeatability. We also demonstrate a diversity of applications for various active photonic, optoelectronic, and electrical devices, such as a zero-bias photodetector enabling pico-Watt level sensitivity whilst allowing for a dense integration on-chip with a repeatable transfer precision around <10 μm, in the current implementation. This 2D material transfer system can be upgraded by automation, improving the accuracy, throughput, speed, and reproducibility. This robust and efficient transfer system provides a standard medium for expediting research and commercial large-scale integration of 2D materials toward making 2D material-based integrated devices for a wide range of applications.

The controller/processing device can be any suitable device, such as a computer, server, mainframe, processor, microprocessor, PC, tablet, smartphone, or the like. The processing devices can be used in combination with other suitable components, such as a display device (monitor, LED screen, digital screen, etc.), memory or storage device, input device (touchscreen, keyboard, pointing device such as a mouse), wireless module (for RF, Bluetooth, infrared, WiFi, etc.). The information may be stored on a computer hard drive, on a CD ROM disk or on any other appropriate data storage device, which can be located at or in communication with the processing device. The entire process is conducted automatically by the processing device, and without any manual interaction. Accordingly, unless indicated otherwise the process can occur substantially in real-time without any delays or manual action.

The operation of the processing device can further be implemented by computer software that permits the accessing of data from an electronic information source. The information may be stored on a computer hard drive, on a CD ROM disk or on any other appropriate data storage device or medium. The system can also be implemented on the cloud and comprise a cloud computing system which provide access via the Internet to shared computing resources, such as servers, storage devices, networks, and/or applications on demand or in real time without regard to the location of those resources. And a medium includes one or more non-transitory physical media that together store the contents described as being stored thereon. Embodiments may include non-volatile secondary storage, read-only memory (ROM), and/or random-access memory (RAM). And an application includes one or more computing modules, programs, processes, workloads, threads and/or a set of computing instructions executed by a computing system. Example embodiments of an application include software modules, software objects, software instances and/or other types of executable code.

It is further noted that the description uses several geometric or relational terms, such as circular, parallel, perpendicular, orthogonal, concentric, and flat. In addition, the description uses several directional or positioning terms and the like, such as top, left, right, up, down, distal, and proximal. Those terms are merely for convenience to facilitate the description based on the embodiments shown in the figures. Those terms are not intended to limit the invention. Thus, it should be recognized that the invention can be described in other ways without those geometric, relational, directional or positioning terms. In addition, the geometric or relational terms may not be exact. For instance, walls may not be exactly perpendicular or parallel to one another but still be considered to be substantially perpendicular or parallel because of, for example, roughness of surfaces, tolerances allowed in manufacturing, etc. And, other suitable geometries and relationships can be provided without departing from the spirit and scope of the invention.

Within this specification, the various sizes, shapes and dimensions are approximate and exemplary to illustrate the scope of the invention and are not limiting. The sizes and the terms “substantially” and “about” mean plus or minus 15-20%, more preferably plus or minus 10%, even more preferably plus or minus 5%, most preferably plus or minus 1-2%. In addition, while specific dimensions, sizes and shapes may be provided in certain embodiments of the invention, those are simply to illustrate the scope of the invention and are not limiting. Thus, other dimensions, sizes and/or shapes can be utilized without departing from the spirit and scope of the invention.

The following documents are incorporated herein by reference: [1] Mak K F, Lee C, Hone J, Shan J and Heinz T F 2010 Atomically thin MoS2: A new direct-gap semiconductor Phys. Rev. Lett. 105 2-5. [2] Britnell L, Ribeiro R M, Eckmann A, Jalil R, Belle B D, Mishchenko A, Kim Y, Gorbachev R V, Georgiou T, Morozov S V, Grigorenko A N, Geim A K, Casiraghi, C, Neto A H C and Novoselov K S 2013 Strong Light-Matter Interactions in Heterostructures of Atomicially Thin Films Science 340 1311-15. [3] Bernardi M, Palummo M and Grossman J C 2013 Extraordinary sunlight absorption and one nanometer thick photovoltaics using two-dimensional monolayer materials Nano Lett. 13 3664-70. [4] Mukherjee S, Maiti R, Midya A, Das S and Ray S K 2015 Tunable Direct Bandgap Optical Transitions in MoS2 Nanocrystals for Photonic Devices ACS Photonics 2 760-768. [5] Xia F, Wang H, Xiao D, Dubey M and Ramasubramaniam 2014 A Two-Dimensional Material Nanophotonics Nat. Photonics 8 899.
[6] Lee G H, Yun Y J, Cui X, Petrone N, Lee C H, Choi M S, Lee D Y, Lee C, Yoo W J, Watanabe K, Taniguchi T, Nuckolls C, Kim P and Hone J 2015 Flexible and transparent MoS2 field-effect transistors on hexagonal boron nitride-graphene heterostructures ACS Nano 7 7931-6. [7] Tahersima M H and Sorger V J 2015 Enhanced photon absorption in spiral nanostructured solar cells using layered 2D materials Nanotechnology 26 344005. [8] Wang Q H, Kalantar-Zadeh K, Kis A, Coleman J N and Strano M S 2012 Electronics and optoelectronics of two-dimensional transition metal dichalcogenides Nat. Nanotechnology. 7 699-712. [9] Mattheiss L F 1973 Band structures of transition-metal-dichalcogenide layer compounds Phys. Rev. B 8 3719-40. [10] Liu Y, Xu F, Zhang Z, Penev E S and Yakobson B I 2014 Two-dimensional mono-elemental semiconductor with electronically inactive defects: The case of phosphorus Nano Lett. 14 6782-6.
[11] Zhang H 2015 Ultrathin Two-Dimensional Nanomaterials ACS Nano 9 9451-69. [12] Song L, Ci L, Lu H, Sorokin P B, Jin C, Ni J, Kvashnin A G, Kvashnin D G, Lou J, Yakobson B I and Ajayan P M 2010 Large scale growth and characterization of atomic hexagonal boron nitride layers Nano Lett. 10 3209-15. [13] Xue J, Sanchez-Yamagishi J, Bulmash D, Jacquod P, Deshpande A, Watanabe K, Taniguchi T, Jarillo-Herrero P and LeRoy B J 2011 Scanning Tunnelling Microscopy and Spectroscopy of ultra-flat graphene on hexagonal boron nitride Nat. Materials 10 282-285. [14] Tahersima M H, Birowosuto M D, Ma Z, Coley W C, Valentin M D, Alvillar S N and Sorger V J 2017 Testbeds for Transition Metal Dichalcogenide Photonics: Efficacy of Light Emission Enhancement in Monomer vs Dimer Nanoscale Antennae ACS Photonics 4(7) 1713-1721.
[15] Bhimanapati G R, Lin Z, Meunier V, Jung Y, Cha J, Das S, Xiao D, Son Y, Strano M S, Cooper V R, Liang L, Louie S G, Ringe E, Zhou W, Kim S S, Naik R R, Sumpter B G, Terrones H, Xia F, Wang Y, Zhu J, Akinwande D, Alem N, Schuller J A, Schaak R E, Terrones M and Robinson J A 2015 Recent Advances in Two-Dimensional Materials beyond Graphene ACS Nano 9 11509-39. [16] Li L, Yu Y, Ye G J, Ge Q, Ou X, Wu H, Feng D, Chen X H and Zhang Y Black 2014 phosphorus field-effect transistors Nat. Nano 9 372-7. [17] Xia F, Wang H and Jia Y 2014 Rediscovering black phosphorus as an anisotropic layered material for optoelectronics and electronics Nat. Communications 5 4458. [18] Mak K F and Shan J 2016 Photonics and optoelectronics of 2D semiconductor transition metal dichalcogenides Nat. Photonics 10 216-26.
[19] Chowdhury R K, Maiti R, Ghorai A, Midya A and Ray S K 2016 Novel silicon compatible p-WS 2 2D/3D heterojunction devices exhibiting broadband photoresponse and superior detectivity Nanoscale 8 13429-36. [20] Kang J, Li J, Li S S, Xia J B and Wang L W 2013 Electronic structural Moirè pattern effects on MoS2/MoSe₂ 2D heterostructures Nano Lett. 13 5485-90. [21] Wang Q H, Kalantar-Zadeh K, Kis A, Coleman J N and Strano M S 2012 Electronics and optoelectronics of two-dimensional transition metal dichalcogenides Nat. Nanotechnol. 7 699-712. [22] Plechinger G, Mann J, Preciado E, Barroso D, Nguyen A, Eroms J, Schueller C, Bartels L and Korn T 2014 A direct comparison of CVD-grown and exfoliated MoS2 using optical spectroscopy Semiconductor Science and Technology 29(6) 064008.
[23] Ma Z, Hemnani R, Bartels L, Agarwal R and Sorger V J 2017 2D Materials in Electro-optic Modulation: energy efficiency, electrostatics, mode overlap, material transfer and integration arXiv preprint arXiv:1708.05986. [24] Schneider G F, Calado V E, Zandbergen H, Vandersypen L M K and Dekker C 2010 Wedging transfer of nanostructures.Nano Lett. 10 1912-6. [25] Zomer P J, Dash S P, Tombros N, and Van Wees B J 2011 A new transfer technique for high mobility graphene devices on commercially available hexagonal boron nitride Appl. Phys. Lett. 99 232104. [26] Li N, Liu K, Sorger V J and Sadana D K 2015 Monolithic III-V on silicon plasmonic nanolaser structure for optical interconnects Sci. Rep. 5 1-9.
[27] Liu K, and Sorger V J 2015 Electrically-driven carbon nanotube-based plasmonic laser on silicon Opt. Mater. Express 5 1910. [28] Lotsch B V 2015 Vertical 2D Heterostructures Annu. Rev. Mater. Res. 45 85-109. [29] Castellanos-Gomez A, Buscema M, Molenaar R, Singh V, Janssen L, Van Der Zant H S J and Steele G A 2014 Deterministic transfer of two-dimensional materials by all-dry viscoelastic stamping 2D Mater. 1 011002. [30] Li H, Wu J, Huang X, Lu G, Yang J, Lu X, Xiong Q and Zhang H 2013 Rapid and reliable thickness identification of two-dimensional nanosheets using optical microscopy ACS Nano 7 10344-53. [31] Late D J, Liu B, Matte H S S R, Rao C N R and Dravid V P 2012 Rapid characterization of ultrathin layers of chalcogenides on SiO₂/Si substrates Adv. Funct. Mater. 22 1894-905. [32] Chen Y F, Liu D, Wang Z G, Li P J, Hao X, Cheng K, Fu Y, Huang L X, Liu X Z, Zhang W L and Li Y R 2011 Rapid determination of the thickness of graphene using the ratio of color difference J. Phys. Chem. C 115 6690-6693. [33] Meitl M A, Zhu Z T, Kumar V, Lee K J, Feng X, Huang Y Y, Adesida I, Nuzzo R G and Rogers J A 2006 Transfer printing by kinetic control of adhesion to an elastomeric stamp Nat. Materials 5 33-8. [34] Amin R, Khurgin J B and Sorger V J 2017 Waveguide-based Electroabsorption Modulator Performance arXiv preprint arXiv:1712.02837.

The foregoing description and drawings should be considered as illustrative only of the principles of the invention. The invention may be configured in a variety of shapes and sizes and is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A material transfer system for transferring 2-dimensional (2D) material to or from a substrate, said system comprising:
a transfer apparatus having a transfer material holder for retaining a transfer material; and
a stamping apparatus having an intermediate portion with a longitudinal axis and a distal end portion, said distal end portion having a proximal section, middle section and distal section forming a distal end face, said middle section curved with respect to the longitudinal axis to form a stamper contact surface at said middle section, said stamper contact surface configured to contact the transfer material.

2. The system of claim 1, said curved middle section having an outer-facing surface along a length of said distal end portion, said stamper contact surface positioned at the outer-facing surface.

3. The system of claim 1, said distal end portion forming a hook shape.

4. The system of claim 1, said middle section of said distal end portion having a circular cross-section.

5. The system of claim 1, wherein said intermediate portion is held at 45 degree angle with respect to said transfer material.

6. The system of claim 1, further comprising:
an imaging device that captures an image of a flake located on the 2D material;
a plurality of stamping apparatus each having a stamper contact surface with a different size and/or shape; and
a processing device configured to determine a size and/or shape of the flake from the captured image and select one of said plurality of stamping apparatus based on the size and/or shape of the flake.

7. The system of claim 6, said processing device further configured to determine an offset based on the size of the selected one of said plurality of stamping apparatus to compensate for variation in stretching of the transfer material.

8. The system of claim 1, wherein the stamper contact surface is offset with respect to the transfer material based on a size of the stamping apparatus to compensate for variation in stretching of the transfer material.

9. The system of claim 1, wherein the stamper contact surface is positioned with respect to the transfer material based on a size of the stamping apparatus to compensate for variation in stretching of the transfer material.
